(19) United States
(12) Patent Application Publication
(10) Pub. No.: US 2015/0032467 A1
(43) Pub. Date: Jan. 29, 2015

(54) SYSTEMS AND METHODS FOR PERFORMING MULTIDIMENSIONAL QUERIES ON HEALTHCARE PROVIDER INSTITUTIONAL DATA

(71) Applicant: The Advisory Board Company, Washington, DC (US)

(72) Inventors: Brandon James Rapp, Gaithersburg, MD (US); Andrew Osterman, Hancock, NH (US); Edward Hughes, Falls Church, VA (US); Mathew Imregi, Fairfax, VA (US)

(21) Appl. No.: 14/444,688

(22) Filed: Jul. 28, 2014

Related U.S. Application Data
(60) Provisional application No. 61/859,095, filed on Jul. 26, 2013.
(60) Provisional application No. 61/859,634, filed on Jul. 29, 2013.

(51) Int. Cl. G06Q 10/06; G06Q 50/22

(52) U.S. Cl. CPC G06Q 10/0639; G06Q 10/067; G06Q 50/22
USPC 705/2

(57) ABSTRACT

Systems and methods disclosed herein provide tools that provide institutions financial visibility in new and/or reformed initiatives by providing insight into the consistency and efficiency of relevant services. A multidimensional query may be performed on institutional data to generate a results set. A baseline model may be generated based off of the results set. One or more adjustments to the baseline model may then be applied to generate a predictive model. The predictive model may then be compared to the baseline model to generate a predicted change in the financial metrics.

### PRIORITY

This application claims the benefit of, and priority to, U.S. Provisional Application No. 61/859,095, filed on Jul. 26, 2013, and U.S. Provisional Application No. 61/859,634, filed on Jul. 29, 2013, both of which are hereby incorporated by reference in their entirety.

### BACKGROUND

Institutions often enter into different business arrangement with different customers and/or providers. As is often the case, one of the parties to the arrangement may propose changes to the agreement. However, it is generally hard to determine what effects will ultimately result from the proposed changes. It is with respect to this general environment that embodiments of the present technology have been contemplated.

### SUMMARY

The present disclosure describes exemplary systems, methods, and user interfaces that may be employed to do predictive modeling of financial metrics. In embodiments, a multidimensional query may be performed on historical institutional data to generate a results set. A baseline model may be generated based off the results set. One or more adjustments to the baseline model may then be applied to generate a predictive model. The predictive model may then be compared to the baseline model to generate a predicted change in the financial metrics associated with the models.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The same number represents the same element or same type of element in all drawings.

FIG. 1 illustrates exemplary vertical and horizontal relationships.

FIG. 2 is an embodiment of a system for performing multidimensional queries on institutional data.

FIG. 3 is an embodiment of a method for analyzing financial metrics using historical institutional data.

FIG. 4 is an embodiment of a method for generating a predictive model.

FIG. 5 is an embodiment of a webpage that may provide users the ability to define multidimensional queries.

FIG. 6 provides an exemplary embodiment a of patient criteria user interface.

FIGS. 7A and 7B illustrate an exemplary embodiment of a trigger criteria user interface.

FIG. 8 illustrates an exemplary user interface having a pop-up element that may be used to edit selected trigger events.

FIGS. 9A and 9B illustrate an exemplary embodiment of a claim criteria user interface.

FIG. 10 is an embodiment of a procedures user interface.

FIG. 11 is an embodiment of another procedures user interface.

FIG. 12 is an exemplary procedures user interface with adjustable slide elements.

FIG. 13 illustrates an exemplary user interface having a pop-up element that permits selection of columns to be displayed.

FIG. 14 provides an exemplary user interface that allows a user to select details of specific codes from the procedure user interface.

FIGS. 15A and 15B provide an exemplary spreadsheet view of population data.

FIG. 16 illustrates an exemplary patient user interface.

FIG. 17 illustrates an exemplary physician user interface.

FIG. 18 illustrates an exemplary diagnosis user interface.

FIG. 19 is an embodiment of an avoidable care user interface.

FIG. 20 is an embodiment of a post-acute care user interface.

FIG. 21 is an embodiment of a payers user interface.

FIG. 22 is an embodiment of a user interface presenting a drilled down view of payer data.

FIG. 23 is an embodiment of a patient detail user interface.

FIG. 24 illustrates an embodiment of a claim detail user interface.

FIG. 25 is an embodiment of a modeling user interface.

FIG. 26 is an embodiment of a modeling user interface for accepting adjustments.

FIG. 27 is an embodiment of a modeling user interface for tracking stop loss metrics.

FIG. 28 illustrates an alternate embodiment of a financial metrics user interface.

FIG. 29 illustrates an alternate view of a modeling user interface.

FIG. 30 illustrates an exemplary embodiment of an overview graph illustrating observation time for a particular population.

FIG. 31 illustrates and alternate view displaying metrics relate to a specific population over time.

FIG. 32 illustrates one example of a suitable operating environment in which one or more of the present embodiments may be implemented.

### DETAILED DESCRIPTION

Systems and methods disclosed herein provide tools that provide institutions financial visibility in new and/or reformed initiatives by providing insight into the consistency and efficiency of relevant services. Embodiments disclosed herein provide mechanisms that may be used to provide information related to the financial value of services provided by an institution and/or information related to risk-based contract terms that the facility may be negotiating with a payment provider. In exemplary embodiments, an institution is a health care provider such as a hospital, a network of hospitals, an individual doctor, etc. While embodiments disclosed herein are described with respect to these exemplary institutions, one of skill in the art will appreciate that the embodiments disclosed herein may be practiced with other types of institutions, such as, but not limited to, educational institutions, governmental institutions, corporate institutions, non-profit institutions, etc.

The present disclosure describes exemplary systems, methods, and user interfaces that may be employed to do predictive modeling of financial metrics. Demand by clients and/or payers often require an organization to change the way it performs business. The changes may be as simple as charging (or receiving) a different amount for products and/or services performed. However, in large organizations it may be difficult to determine whether the new proposed price and/or payment has a positive or negative effect on the organization's financial metrics. This may be due to the complex relationship between supplies, costs, and/or revenues. The difficulty in determining an effect on financial metrics may be further complicated when a proposed change also includes a change in practice. In such instances, the change in practice may affect the financial metrics for an organization across the board (e.g., a change proposed under one contract may affect financial metrics of other contracts the organization has committed to). Embodiments disclosed herein provide a means for estimating the changes in financial metrics that may result from a change in charges, payments, and/or practices based upon an institution's historical data.

The field of healthcare provides an example of organizations that are often subjected to changes in how the organizations receive compensation for their services. For example, a healthcare provider (e.g., a doctor, a medical facility such as a hospital, a network of related medical facilities, etc.) enters into a contract with different payers such as, but not limited to, different insurance providers, government organizations (e.g., Medicare and Medicaid), individual patients, and/or suppliers. Although the healthcare provider provides the same type of care to a patient regardless of the payer that insures the patient, the healthcare provider may be compensated differently for the same service by the different payers. Furthermore, in light of recent changes in law and regulations, healthcare providers may be incentivized in some contracts to reduce the amount of follow up care required. The incentives may take the form of risk shifting. For example, payers may refuse to pay a healthcare provider for any avoidable follow up care. In practice, payers may try to shift the risk by offering bundled (or flat fee) payments to healthcare providers. For example, a payer may enter into a contract with a healthcare provider to pay a specific amount for a procedure, regardless of the follow up work required on a patient. In doing so, the healthcare provider may be incentivized to ensure that the patient does not require a follow up visit, which may result in improved care for patients.

However, it may be very difficult for a healthcare provider to determine the financial metrics (e.g., costs, revenues, margins, etc.) that result from entering into such contracts. For example, it may be difficult for a healthcare provider to determine all of the relationships implicated by a proposed change in payment or procedures. In embodiments, the relationships may be type of cause and effect relationship between one or commercial entities, terms of contracts, etc. In one embodiment, the proposed contract with the payer may have a vertical effect. That is, the contract only affects financial metrics between the payer and the healthcare provider. An example of a change that has a vertical effect is a change in the payment received for a specific procedure. For example, a decision by one payer to reimburse a hospital 10% less for an appendectomy will not affect what the hospital is paid by other payers. In other embodiments, the proposed contract change with one payer may have a horizontal effect across multiple payers. That is, the proposed contract may not only affect the financial metrics with the payer but may also affect the financials metrics of other contracts or agreements entered into with other payers. For example, a proposed contract that may have a horizontal affect may require a change in practice. Because the healthcare provider will not differentiate between patients based upon the payer that reimburses the provider for the patient, changes in practices are generally applied across the board. As such, the changes in practice may also affect the financials metrics derived from other contracts and the effects may not be symmetrical across payer contracts. In embodiments, the changes may have both vertical and horizontal effects.

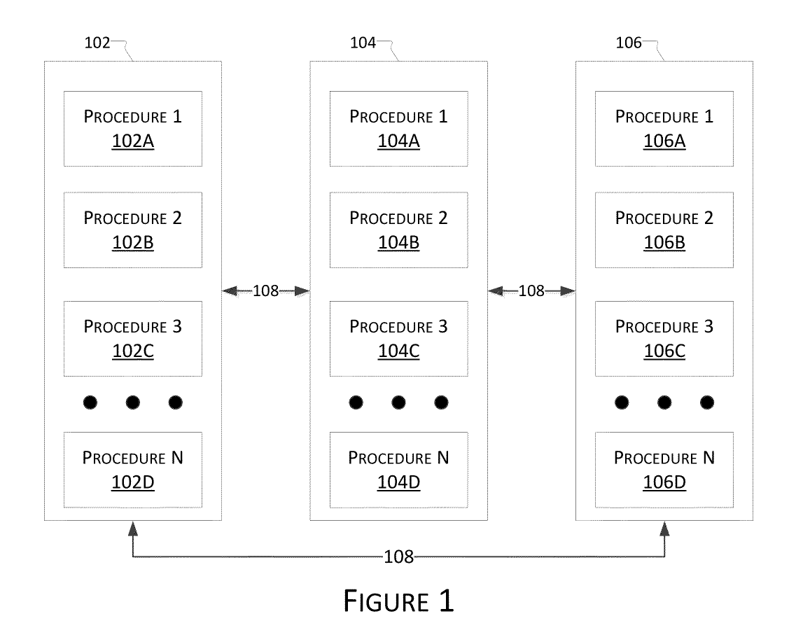

FIG. 1 illustrates exemplary vertical and horizontal relationships of an organization. FIG. 1 illustrates three different vertical relationships, relationship 102, relationship 104, and relationship 106. To continue with the healthcare related example, each vertical relationship may be defined by a different contract with a different payer (e.g., insurance company, government, etc.). Vertical relationship 102 may include a number of different procedures such as Procedure 1 102A, Procedure 2 102B, Procedure 3 102C, and Procedure N 102D. A procedure may be an operation, a treatment, a type of practice, the type of supplies used, etc. One of skill in the art will appreciate that the relationship 102 may include more or fewer procedures that the illustrated procedures. Relationship 102 may be a contract defining the procedures covered by a payer and/or the amount the payer will compensate the healthcare provider for each procedure (e.g., Procedure 1 102A, Procedure 2 102B, Procedure 3 102C, and Procedure N 102D). While the relationship 102 is described as being related to different healthcare related procedures, one of skill in the art will appreciate that the relationships described herein may include other items or services and should not be limited to the field of healthcare.

Similarly, relationship 104 may include a number of procedures (Procedure 1 104A, Procedure 2 104B, Procedure 3 104C, and Procedure N 104D) related to a second payer and a second contract. Finally, relationship 106 may include a number of procedures (Procedure 1 106A, Procedure 2 106B, Procedure 3 106C, and Procedure N 106D) related to a third payer and a third contract. The procedures included in vertical relationships 102, 104, and 106 may be the same or they may be different. An exemplary change that has only a vertical effect may be a change by a specific payer, e.g., a payer associated with relationship 102 in the amount it will pay the healthcare provider for one or more procedures. Such a change would affect the financials for one or more procedures included in relationship 102, that is, the affect may affect at least one of Procedure 1 102A, Procedure 2 102B, Procedure 3 102C, and Procedure N 102D. Such a change, however, may not have any effect on relationship 104 and its related procedures (Procedure 1 104A, Procedure 2 104B, Procedure 3 104C, and Procedure N 104D) or relationship 106 and its related procedures (Procedure 1 106A, Procedure 2 106B, Procedure 3 106C, and Procedure N 106D).

However, if the change proposed or required by the payer associated with vertical relationship 102 requires additional actions, such as, for example, a change in types of treatment provided, changes in the type of supplies used, changes in practice related to a procedure, and/or other clinical changes, such changes may have a horizontal effect. That is, healthcare organizations generally provide the same service to patients regardless of the patient provider. As such, if the payer associated with vertical relationship requires a change to Procedure 1 102A, similar changes may be implemented with respect to Procedure 1 104A and Procedure 1 106A. As such, the changes in relationship 102 may have a horizontal affect (indicated by arrows 108) on relationship 104 and 106. Similarly, changes in relationships 104 and/or 106 may affect relationship 102.

Embodiments disclosed herein provide systems, methods, and/or exemplary user interfaces that may be used to identify the interrelationships within a single agreement (e.g., contract, operating agreement, etc.) that have an effect only on the single agreement (e.g., vertical effects) and/or the interrelationships between multiple agreements (e.g., horizontal effects) that have an effect on more than one agreement. By doing so, the systems, methods, and exemplary user interfaces disclosed herein may be employed to do predictive modeling to determine how a proposed change in a specific agreement will affect the financial metrics for the specific agreement, the financial metrics of other agreements, and/or the overall financial metrics for an organization. The embodiments disclosed herein may use historical institutional data to provide a predictive model that may be used to determine whether the change has a positive or negative effect on the organization.

Embodiments disclosed herein may be used to determine whether a change in practice will have an overall positive or negative financial effect. For example, a first insurance provider may propose a new contract in which a healthcare provider will receive $1,500.00 for an appendectomy instead of $1,000 per appendectomy; however, the insurance provider may condition the new reimbursement amount on the healthcare provider reducing readmission rates of patients who have an appendectomy from 12% to 10%. In addition, the contract between a second insurance provider and the healthcare provider may provide for paying the healthcare provider $750 for an appendectomy but also paying $750 each time an appendectomy patient is readmitted. As such, if the healthcare provider changes its clinical practices to reduce readmission rates as required by the proposed contract from the first insurer, the healthcare provider will receive less payment (due the fewer admissions) from the second provider. This is due to the fact that the changes in practices that result in fewer readmissions are generally employed to all patients, not just patients covered by a certain provider. Embodiments disclosed herein may be used to analyze whether the change in readmission rates will result in a positive or negative financial effect for the healthcare provider overall. Although the healthcare provider will generally attempt to implement clinical changes that benefit patients, the healthcare provider may use that information to negotiate incentives and contract provisions that are ultimately feasible given the healthcare provider's other obligations.

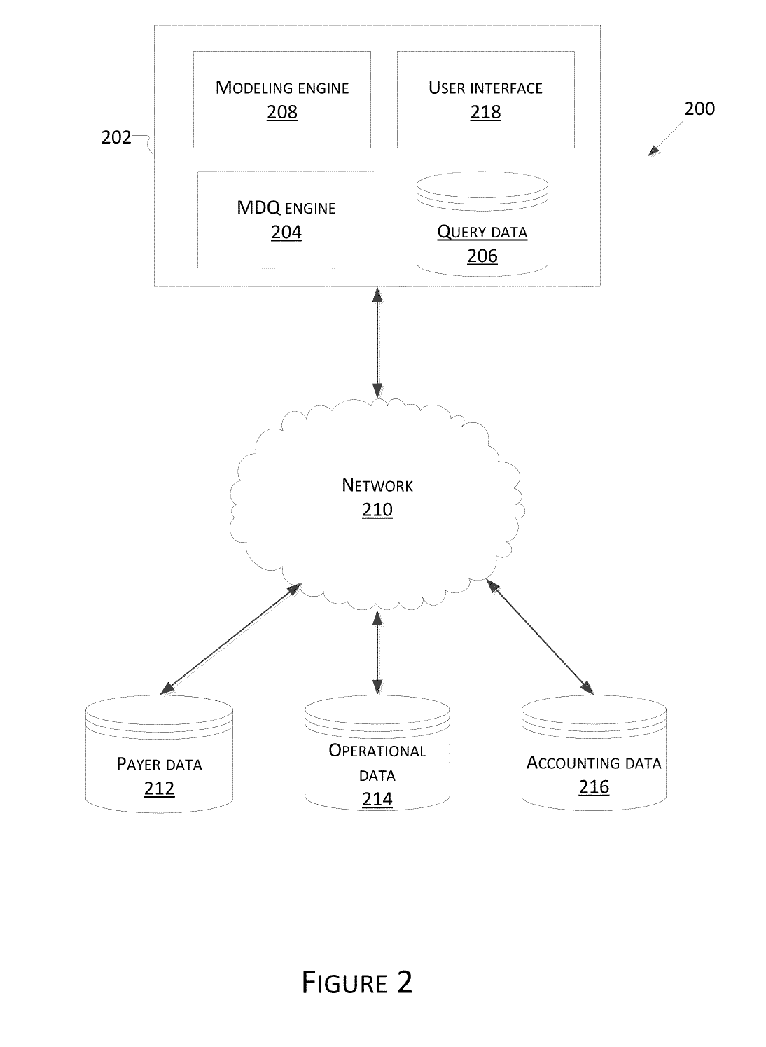

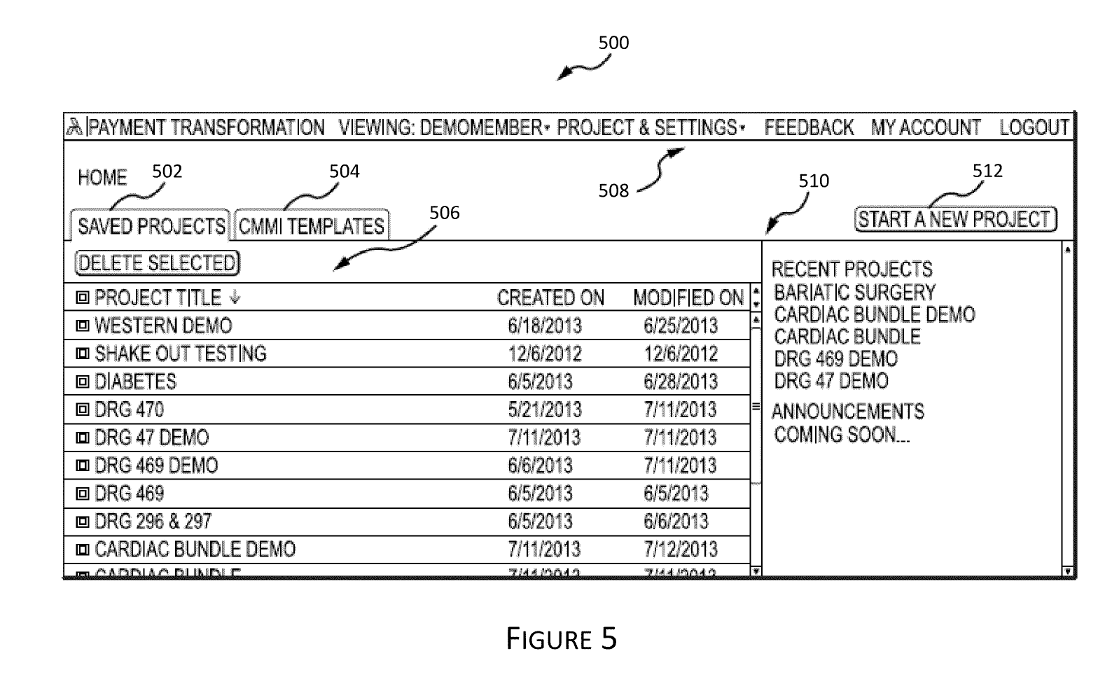

FIG. 2 is an embodiment of a system 200 for performing multidimensional queries on institutional data. In embodiments, the system 200 includes a predictive modeler 202 that accesses institutional data, such as payer data 212, operational data 214, and accounting data 216, over a network 210. Predictive modeler 202 may be implemented using hardware, such as the computing operating environment described herein with respect to FIGS. 5-31. In other embodiments, predictive modeler 202 may be implemented as software that is executed by one or more computing devices. The predictive modeler 204 may query historical data of an institution to identify and organize information that may be needed to provide users with the information necessary to consider, test, or estimate the financial savings or costs that may result from changes to business processes, implications of risk-based contracts, changes to payment plans or cost structures, etc. Embodiments disclosed herein may sift through an entire population's worth of claims and analyze the results in a variety of ways to call out inefficiencies, highlight variation, simulate an episode of care around an anchor event or even assess the clinical performance of an entire sub-population. In embodiments, the network 210 may be a local area network (LAN), a working area network (WAN), a cellular network, a WiFi network, a plain old telephone service (POTS) network, the Internet, or any other type of network. In embodiments, the predictive modeler 202 may access different types of institutional data. The institutional data may be part of a single system, may be in multiple disparate systems that are part of an organization, or may be located in multiple disparate systems that are part of an organizational network. Referring back to the healthcare example, the institutional data may be stored on a hospital's system, stored in multiple systems in a hospital, and/or stored in multiple systems of a network of hospitals and/or doctor's offices or other health providers.

In embodiments, the predictive modeler 202 may access different types of data to perform the predictive modeling. For example, one type of historical data of an institution (also referred to herein as “institutional data”) may be payer data 212. Payer data 212 may include data related to a contract with one or more payers, such as, but not limited to, the products and/or services paid for, the amount of compensation provided for a product and/or services, etc. For example, payer data 212 may include data related to the types of procedures covered by a specific insurer as well as the amount of compensation the insurer provides for the procedures. Operational data 214 may also be used for the predictive modeling. Operational data 214 may include data such as the types of supplies used by an organization, the amount of supplies used, the cost of supplies, the practices performed by the organization, etc. Returning to the healthcare example, operational data may include, but is not limited to, frequency of use of a specific supply (e.g., a specific stent, implant, medication, etc.), the cost of a supply, information about the personnel involved in a specific treatment or operation (e.g., surgeons, nurses, doctors, etc.), the types of procedures performed, and/or patient related data such as a patient's length of stay, readmission rates, mortality rates, infection rates, etc. Institutional data may also include accounting data 216. In embodiments, accounting data 216 includes tax information, revenue data, cost data, margin data, accounts receivable/payable data, etc. While exemplary forms of institutional data have been described herein, one of skill in the art will appreciate that other types of institutional data may be used to perform predictive modeling without departing from the spirit or scope of this disclosure.

In embodiments, the predictive modeler 202 includes a multidimensional query (MDQ) engine 204. In embodiments, the MDQ engine 204 may receive data used to define multiple dimensions of a query. An exemplary multidimensional query may be a three-dimensional query. In one embodiment, the dimensions defining the three-dimensional query may include a triggering event, patient criteria, and claims type. In embodiments, the triggering event may identify a specific procedure, supply, practice, location etc. The patient criteria may define factors related to a patient, such as, for example, age, sex, length of stay, health status, etc. Claims type may relate to a type of claim made by a patient, hospital, payer, etc. While specific dimensions and factors are described herein, one of skill in the art will appreciate that other types of dimensions and/or factors may be employed with the disclosed embodiments. Upon receiving the dimensions, related query factors, and/or other query related instructions, MDQ engine 204 may perform the multidimensional query on the institutional data. In one embodiment, predictive modeler 202 may aggregate the institutional data and store it locally (e.g., in query data store 206). In such embodiments, MDQ engine 204 may perform the multidimensional query on data in query data store 206. In alternate embodiments, MDQ engine 204 may remotely access one or more institutional data stores via a network to perform the query (e.g., access payer data 212, operation data 214, and/or accounting data 216 via network 210. Performance of the multidimensional query may generate a set of results. The multidimensional query results may be stored locally, such as in query data store 206.

Predictive modeler 202 may also include modeling engine 208. In embodiments, modeling engine 208 may generate one or more models using the query results from MDQ engine 204. In one embodiment, modeling engine 208 may perform operations such as calculating costs, charges, reimbursements, length of stay, readmission rates, etc. using the results of the multidimensional query. In embodiments, the modeling engine 208 may determine and/or generate a baseline model that identifies a relevant population. Returning to the healthcare example, a relevant population may include patients, procedures, treatments, etc. In embodiments, the baseline model may represent the institutions current financial metrics (e.g., the financial metrics based upon contracts, agreements, practices, etc.) currently in place or being performed by the institution. In addition to determining and/or generating the baseline model, modeling engine 208 may receive input that identifies one or more adjustable parameters. The modeling engine 208 may apply the one or more adjustable parameters to the population to generate a predictive model. If an adjustment to a parameter has only a vertical effect, it is considered a “vertical” parameter. If the effect of adjusting a parameter is horizontal, it is considered a “horizontal” parameter. In generating the predictive model, the modeling engine 208 may perform an analysis to determine the vertical and/or horizontal effect(s) of the changes based upon the adjustable parameters. The modeling engine may determine financial metrics (e.g., costs, revenues, margins, etc.) for the predictive model and compare it to financial metrics for the baseline model. Comparing the financial metrics of the baseline and predictive models may be used to determine differences between the financial metrics of each model. The differences may be used to determine whether a proposed change (e.g., a change based upon negation of a new contract with a payer, a change in practices, etc.) results in a positive or negative financial change for the institution.

Predictive modeler 202 may also include a user interface component 218 operable to generate and display a user interface (or send instructions that cause another device to display a user interface). The exemplary user interfaces disclosed herein may be generated by user interface component 218. In embodiments, user interface component 218 generates a user interface capable of receiving one or more dimensions and/or factors related to the one or more dimensions to perform the multidimensional query. The user interface component 218 may be used to display the results of the multidimensional query. The user interface component 218 may also display information about an identified population and/or information about a baseline model (e.g., costs, revenues, margins). Additionally, the user interface module 218 may generate a user interface that simultaneously displays information about the predictive model and the baseline model. For example, a user interface may be generated that simultaneously displays an adjustment, the financial metrics (or a summary of the financial metrics) of the baseline model, and/or the financial metrics (or a summary of the financial metrics) of the predictive model. In such embodiments, the user interface may also indicate the differences between the financial metrics of the baseline and predictive model. Exemplary user interfaces that may be generated by user interface component 208 are described with respect to FIGS. 5-31.

While the system 200 is illustrated as including several exemplary components, one of skill in the art will appreciate that systems having more or fewer components may be employed without departing from the scope of this disclosure. For example, in other embodiments, more or fewer sources of institutional data may be accessed. Additionally, while predictive modeler 202 is described as having discrete components that perform different actions, one of skill in the art will appreciate that, in alternate embodiments, predictive modeler 202 may include more or fewer components. For example, MDQ engine 204, modeling engine 208, and/or user interface component 208 may be combined into a single component.

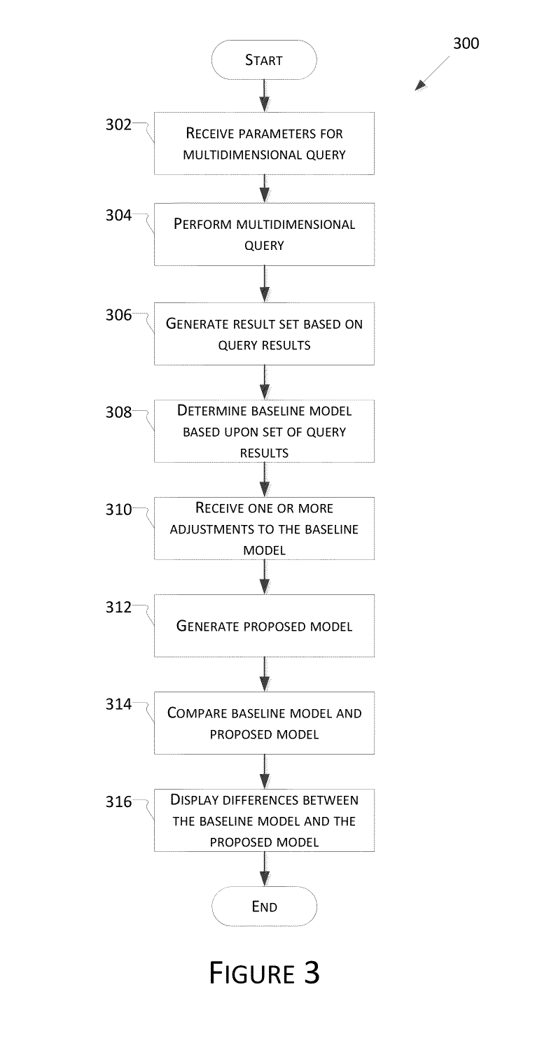

Having described a system that may be employed to perform predictive modeling, embodiments of various methods for performing predictive modeling are now described. The methods disclosed herein may be implemented and performed using hardware, software, or a combination of hardware and software. In embodiments, the methods disclosed herein may be performed by a predictive modeler, such as predictive modeler 202 of FIG. 2. FIG. 3 is an embodiment of a method 300 for analyzing financial metrics using historical institutional data. Flow begins at operation 302 where parameters are received that define a multidimensional query. In embodiments, the received parameters include an indication of one or more dimensions upon which to perform the multidimensional query. For example, the received parameters may define a three-dimensional query including a triggering event dimension, a patient criteria dimension, and a claims type dimension. However, in alternate embodiments, the received parameters may define more or fewer dimensions having the same or different types. In addition to defining the dimensions for the multidimensional query, the parameters received at operation 302 may include one or more factors for the query. In embodiments, the dimensions may define a type of data to perform the query on while the factors define the query search parameters. Upon receiving the multidimensional query parameters, flow continues to operation 304 where a multidimensional query is performed on the institutional data. As previously described, in embodiments the multidimensional query may be performed using data from disparate data sources. In alternate embodiments, the institutional data may be aggregated into a single data store and the multidimensional query may be performed on data from the single data store. In further embodiments, other types of information may be calculated for the baseline model

Flow continues to operation 306 where a result set is generated based upon the multidimensional query results. In one embodiment, the result set may include all of the results returned by the multidimensional query. In other embodiments, the result set may be generated by applying a function to the results of the multidimensional query (e.g., filtering the results, modifying the results, reordering the results, etc.). Flow continues to operation 308 where a baseline model is determined from the results set. In embodiments, the baseline model may be generated by performing one or more calculations using the results set generated at operation 306. For example, baseline model may be generated by calculating costs, charges, reimbursements, profit margins, etc. using the result set. In further embodiments, additional information may be calculated for the baseline model. For example, the average patient length of stay, readmission rates, infection rates, average supply cost (or the cost of an individual supply unit), etc. In embodiments, the baseline model may define a target population which may be affected by a proposed change to generate a predictive model. In embodiments, a population may be a related group of procedures, patients, etc. defined by the results of a MDQ. For example, a representative population may be defined by a MDQ that identifies all patients, procedures, payers, healthcare facilities, etc. related to kidney transplants performed during a certain date range at an institution. As such, the baseline model may be compared against a predictive model to determine whether any proposed changes will have a positive or negative effect.

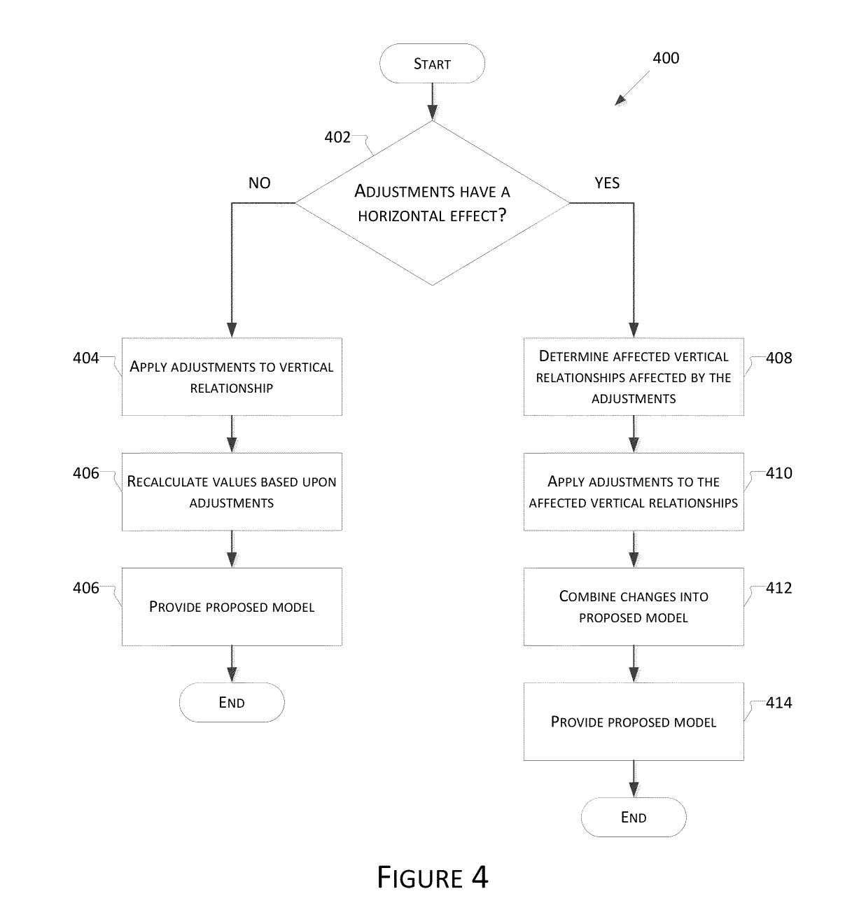

Flow continues to operation 310 where one or more adjustments are received. In embodiments, the one or more adjustments may represent changes to the baseline model. Exemplary changes include a change in the fee received for a service, a change in the cost of a supply, and/or a change in practices. In embodiments, the adjustments may in the form of parameters to apply to the population defined by the baseline model. As such, the adjustments may be changes to the baseline model or adjustments to the factors and dimensions used to generate the baseline model. Upon receiving the adjustments, flow continues to operation 312 where a predictive model is generated based upon the one or more received adjustments. In embodiments, the predictive model may be generated by applying the adjustments to the baseline model. In embodiments, applying the adjustments may include determining vertical and horizontal relationships to identify the vertical and horizontal effects that result from the one or more adjustments. Generation of the predictive model is described in further detail with respect to FIG. 4. In embodiments, generation of the predictive model may also include calculating costs, charges, reimbursements, profit margins, etc. using the result set. In further embodiments, the additional information may be calculated for the predictive model. For example, the average patient length of stay, readmission rates, infection rates, average supply cost, etc. Any information derived from the baseline model may be derived using the predictive model.

Upon generating the predictive model, flow continues to operation 314 where the predictive model is compared to the baseline model. In embodiments, the baseline model represents the current state of an institution. Thus, comparing the predictive model to the baseline model may be used to determine whether a proposed change of parameter(s) will have a positive or negative effect. In embodiments, comparing the baseline model and the predictive model may include comparing the costs, revenues, margins, length of stay, morality rates, etc. In embodiments, comparing the baseline model and predictive model results in the determination of changes between the two models. Flow then continues to operation 316 where the differences between the baseline and predictive model are displayed. For example, in one embodiment a summary of financial metrics for the baseline model and the predictive model may be simultaneously displayed. This allows a user to quickly identify changes between the models. In further embodiments, displaying the changes may include indicating the differences between the models. The differences may be indicated by a percentage of change, a value of the difference between the models, etc. While the present disclosure described specific information that may be displayed at operation 316, any information related to the baseline and predictive models may be displayed.

FIG. 4 is an embodiment of a method for generating a predictive model. In embodiments, the method 400 may be performed as part of operation 312 of FIG. 3. Flow begins at decision operation 402 where a determination is made whether the parameter adjustments have a horizontal effect. In embodiments, the received parameter adjustments affect a single vertical relationship or multiple vertical relationships. For example, a payer may propose changes in reimbursements (e.g., a vertical effect) and/or practices (e.g., a horizontal effect). As previously discussed, an adjustment has a horizontal effect if the adjustment has an effect on additional vertical relationships in addition to the vertical relationship that the adjustment is directed to. If the adjustment does not have a horizontal effect, flow branches NO to operation 404. At operation 404, the adjustments are applied of the population identified in a baseline model. At operation 404, the adjustment may be applied only to the vertical relationship that it was directed towards. For example, if a specific payer proposes changes in reimbursement, the change reimbursement rates will only be applied to the subset of the population related to the payer. Flow continues to operation 406, where a recalculation is performed according to the received adjustments. For example, the adjustments may be applied to the baseline model and a recalculation of costs, charges, reimbursements, profit margins, etc. may be performed. The recalculated values may represent the predictive model. Flow then continues to operation 406 where the predictive model is provided. Providing the predictive model may include saving the predictive model, sending the predictive model to a recipient, application, or other module, etc.

Returning to decision operation 402, if the adjustment has a horizontal effect, flow branches YES to operation 408. At operation 408 a determination is made to identify affected vertical relationships that are affected by the adjustments. In embodiments, the affected vertical relationships may be identified by determining whether a relationship exists between the adjustment and the affected vertical relationships. For example, a determination is made as to whether a proposed change has an effect on any component of the affected relationships. In one embodiment, the relationships may be predefined or may be identified analyzing the population defined by the baseline model to find overlapping characteristics between the different vertical relationships. Once the affected vertical relationships are identified, the adjustment may be applied to the affected vertical relationships and values for the affected vertical relationships are recalculated. Flow then continues to operation 412 where the recalculated values of the affected vertical relationships are combined into a predictive model. Flow then continues to operation 414 where the predictive model is provided. Providing the predictive model may include saving the predictive model, sending the predictive model to a recipient, application, or other module, etc.

predictive modeling of financial metrics, the disclosure will now describe exemplary user interfaces that may be employed by the embodiments disclosed herein. FIG. 5 is an embodiment of a home page 500 that may be accessed to provide users the ability to define multidimensional queries (MDQ), analyze the results of a MDQ, export MDQ results, etc. In embodiments, the home page 500 may comprise two tabs, a Saved Projects tab 502 and a CMMI Templates tab 504. The CMMI Templates tab 504 may provide access to various templates that a user can select to structure and perform a MDQ. The templates may be predefined by the application or created by a user. The saved projects tab 502 may include a listing of previously created projects 506. The user may select a specific saved project by clicking on the project title, e.g., clicking on the “Diabetes” project, or may select multiple saved projects using the check boxes next to each project title.

Web page 500 may also comprise a settings section that allows users to select a specific facility or organization by interacting with the “Viewing” element, adjust project settings by interacting with the “Project & Settings” element, provide feedback by selecting the “Feedback” element, access and/or modify account information and/or settings by selecting the “My Account” element, or Logout of the system by selecting the “Logout” element. Web page 500 may also include an information section 510 that provides a listing of recently accessed projects that allows a user to quickly access the project by clicking on one of the project titles listed under “Recent Projects.” The information section 510 may also include an “Announcement” section that provides news, information about a project or update to an application, etc. Web page 500 may also comprise an interactive graphical user interface (GUI) element that allows a user to create a new project. For example, a user may select the “Start a new project” button 512 to initiate a wizard to create a new MDQ project.

Upon creating a new MDQ project, a user may define various factors for each dimension of the multidimensional query. The defined factors may then be used to perform the multidimensional query. In the exemplary embodiments, the disclosure will describe a three dimensional query related to health care. In the embodiments disclosed herein, the three dimensions comprise patient criteria, trigger conditions, and claim criteria. While specific exemplary embodiments are disclosed herein, one of skill in the art will appreciate that the number and/or type of factors may vary without departing from the scope of this disclosure.

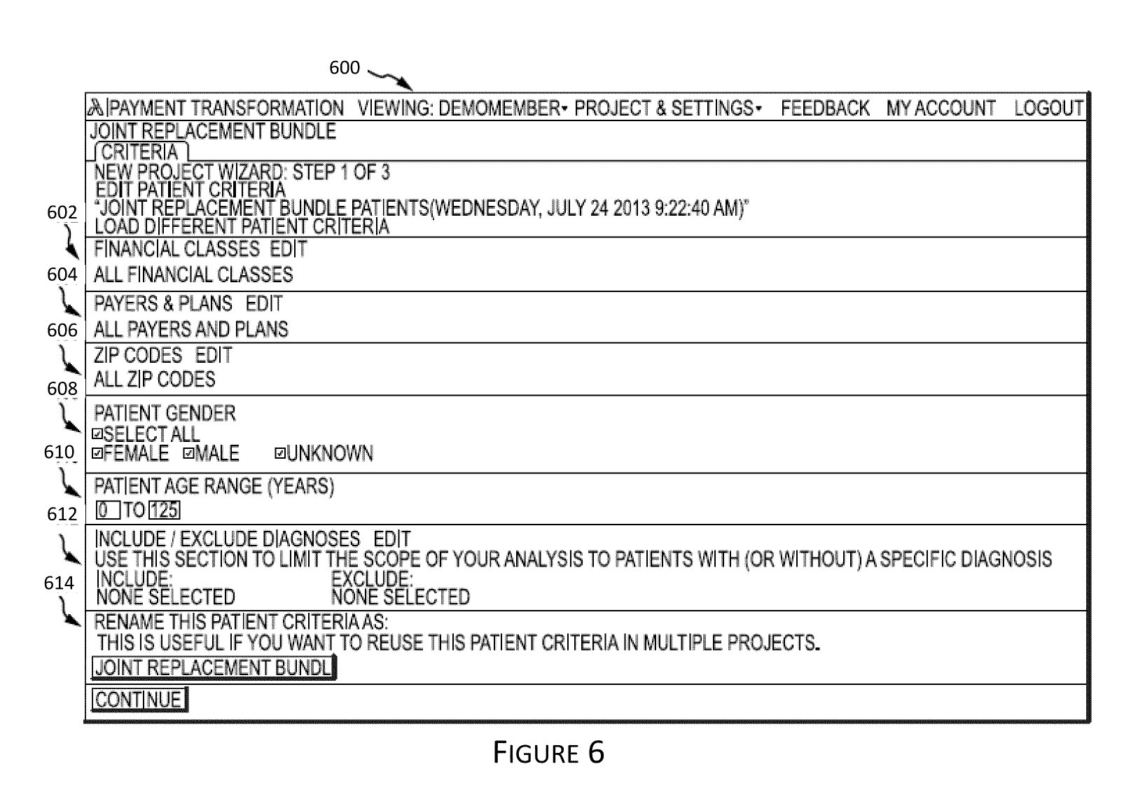

FIG. 6 provides an exemplary embodiment a of patient criteria UI 600 that may be displayed upon creation of a new project, for example, upon the selection of the “Start a new project” button 512 of FIG. 5. In embodiments, the patient criteria UI 600 allows users to define different conditions for a patient criteria factor of a MDQ. The exemplary embodiment comprises a financial section 602, a payers section 604, a geographic section 606, a gender section 608, an age section 610, a diagnosis section 612, and a naming section 614. In this example, patient criteria is a dimension, and elements 602, 604, 606, 608, 610, and 612 allow a user to define factors for the patient criteria dimension for a MDQ.

Financial section 602 allows a user to define one or more financial classes of a patient. For example, the financial class may be defined by income, class status, available assets, etc. Payers section 604 allows a user to define a condition related to the types of payer for a section. Exemplary payer classifications include a private insurance company, a government insurance program (e.g., Medicare or Medicaid), an individual, etc. In further embodiments, information related to a specific payment plan may be included. For example, a specific insurance plan may also be selected or otherwise defined by a user.

In embodiments, geographic section 606 allows a user to define a specific geographic area of patients to include in the query results. The geographic area may be defined by address, zip code, city, county, state, country, region, etc. Gender section 608 allows the user to select the gender of patients to include in the MDQ. Age section 610 may allow a user to define an age range of patients to include in the MDQ. Diagnosis section 612 allows a user to determine whether to include or exclude a specific diagnosis from the MDQ. Finally, naming section 614 allows the user to define a name for the chosen patient criteria factors, such that it can be reused in future projects.

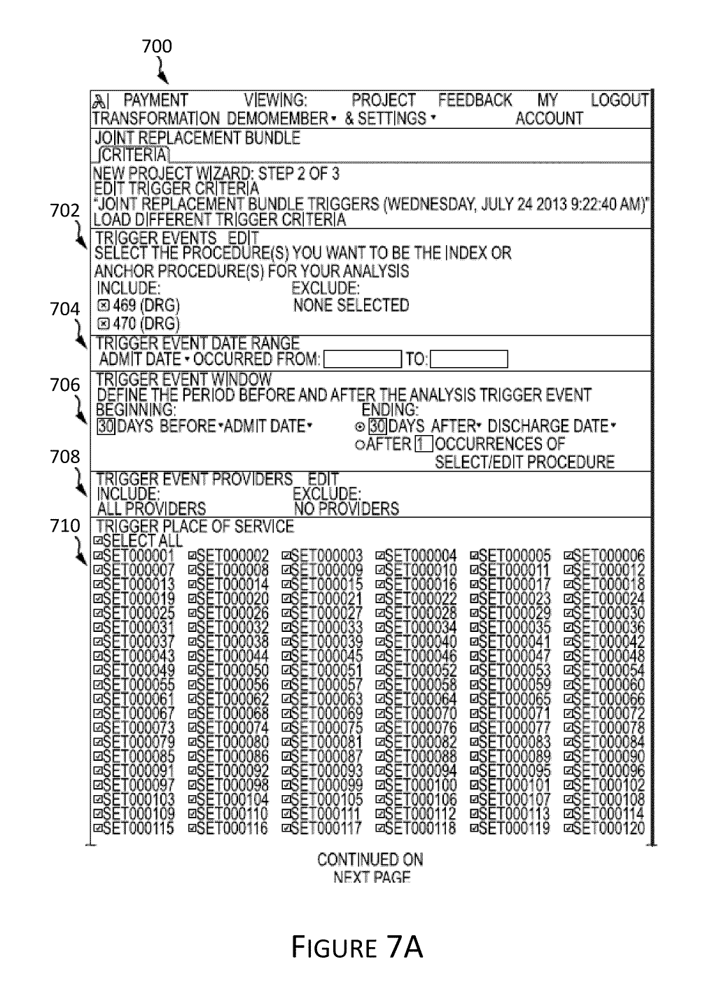

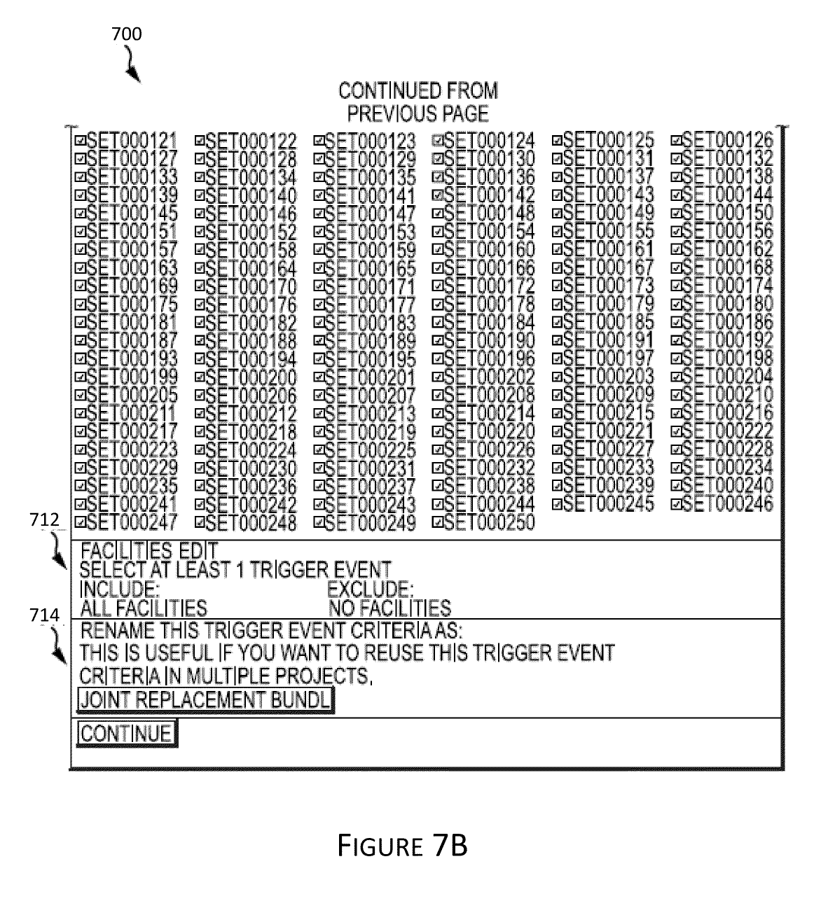

FIGS. 7A and 7B illustrate an exemplary embodiment of a trigger criteria UI 700 that allows a user to define conditions for specific triggers. In the exemplary embodiment, a trigger may be the second factor in a multidimensional query. In embodiments, the triggers define specific events that, when they occur, cause the patient or procedure to be included in the population defined by the MDQ results. For example, a trigger may be a specific event (e.g., heart attack, knee surgery, etc.). In the exemplary embodiment, trigger criteria UI 700 comprises a trigger events section 702, an event date range section 704, an event window section 706, an event provider section 708, a place of service section 710, a facilities section 712, and a naming section 714. In this example, the trigger criteria is a dimension, and elements 702, 704, 706, 708, 710, and 712 allow a user to define factors for the trigger event dimension for a MDQ.

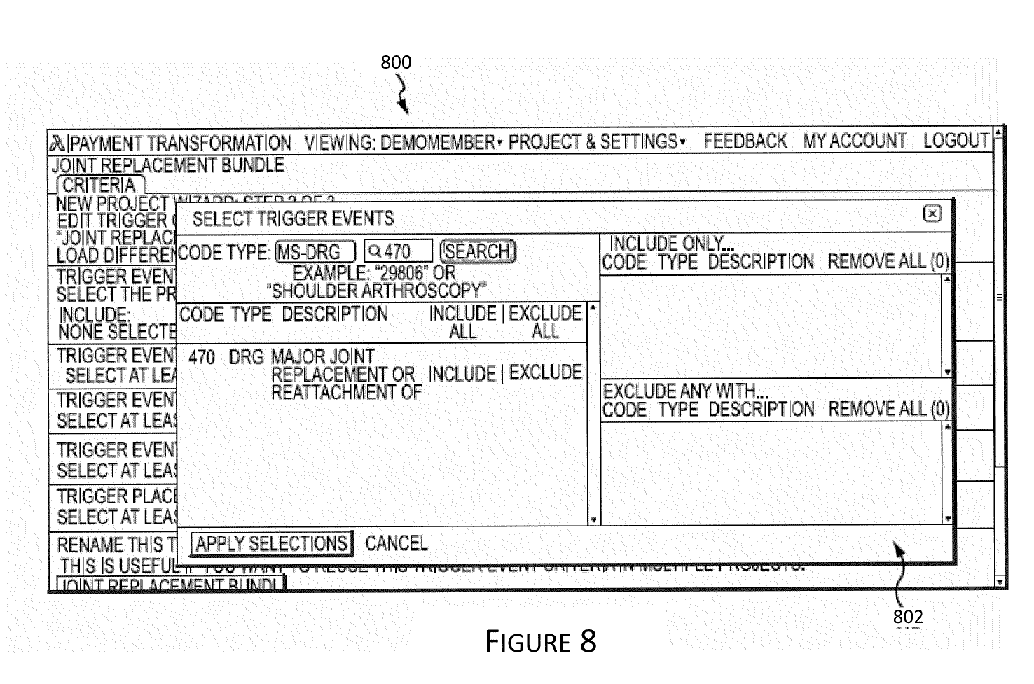

Trigger events section 702 allows the user to select specific triggering events to include or exclude from the MDQ. Trigger events may relate to a type of service, action, or medical event. Exemplary triggering events include surgery, pre operation care, post operation care, a medical event (e.g., a stroke or heart attack), etc. In the exemplary embodiment, the triggering events are defined by a diagnosis related groups (DRG) code system. Exemplary DRG code systems comprise Medicare DRG (CMS-DRG & MS-DRG), Refined DRGs (R-DRG), All Patient DRGs (AP-DRG), Severity DRGs (S-DRG), All Patient, Severity-Adjusted DRGs (APS-DRG), All Patient Refined DRGs (APR-DRG), International-Refined DRGs (IR-DRG), etc. Other type of coding systems may also be used, such as provider or payer specific codes, etc. In other embodiments, the triggering events may be identified by name rather than code. Referring to FIG. 8, the exemplary user interface 800 illustrates a pop-up element 802 that may be displayed upon selecting the “Edit” UI element from the trigger events section 702. The pop-up element allows a user to search for and select specific triggering events by code, name, etc. In the illustrated example, the search criteria are limited to MS-DRG code types and the user has entered a search for the code “470.” The search results may be displayed in the pop-up element 802 that provide a description of the code type as well as interactive elements that allow a user to include or exclude the code from the MDQ results. One of skill in the art will appreciate that other types of search criteria may be used without departing from the scope of this disclosure.

Event date range section 704 allows a user to define a date range for the triggering events to include in the MDQ. The date range may be based around different types of events. For example, the date range may be based around an admission date (e.g., when the patient was admitted to the facility), an event date (e.g., when the patient experienced an event, such as a heart attack), or any other type of event. Event window section 706 allows a user to define a window around a triggering event. The window around the triggering event may be defined as happening before or after a specific date. For example, the window can include data before the admission date to the healthcare facility, after the discharge date from the healthcare facility, or after the occurrence of a specific procedure. While specific examples of type of dates are described herein, other types of dates may be employed.

Event provider section 708 allows the user include or exclude specific providers. In embodiments, a provider may be a doctor, a nurse, a group, or any other type of event provider. In embodiments, event provider section 708 allows a user to limit query results to data related to a specific doctor, nurse, etc. Place of service section 710 allows the user to select specific places of service to include in the MDQ. A place of service may be a department, building, grouping, etc. In embodiments, a place of service may be defined by a specific healthcare facility. For example, a place of service may be a radiology department, a cardiac group, etc. Facilities section 712 allows a user to define specific facilities to include in the MDQ. A healthcare provider, such as a hospital group, may include multiple facilities. The facilities section 712 may allow the user to select specific facilities, e.g., a specific hospital, to include or exclude. Naming section 714 may allow a user to provide a specific name for the trigger event criteria so that it can be stored and reused in other projects. In embodiments, this allows the user to reuse the defined trigger event criteria in multiple projects without having to redefine the trigger criteria for each project.

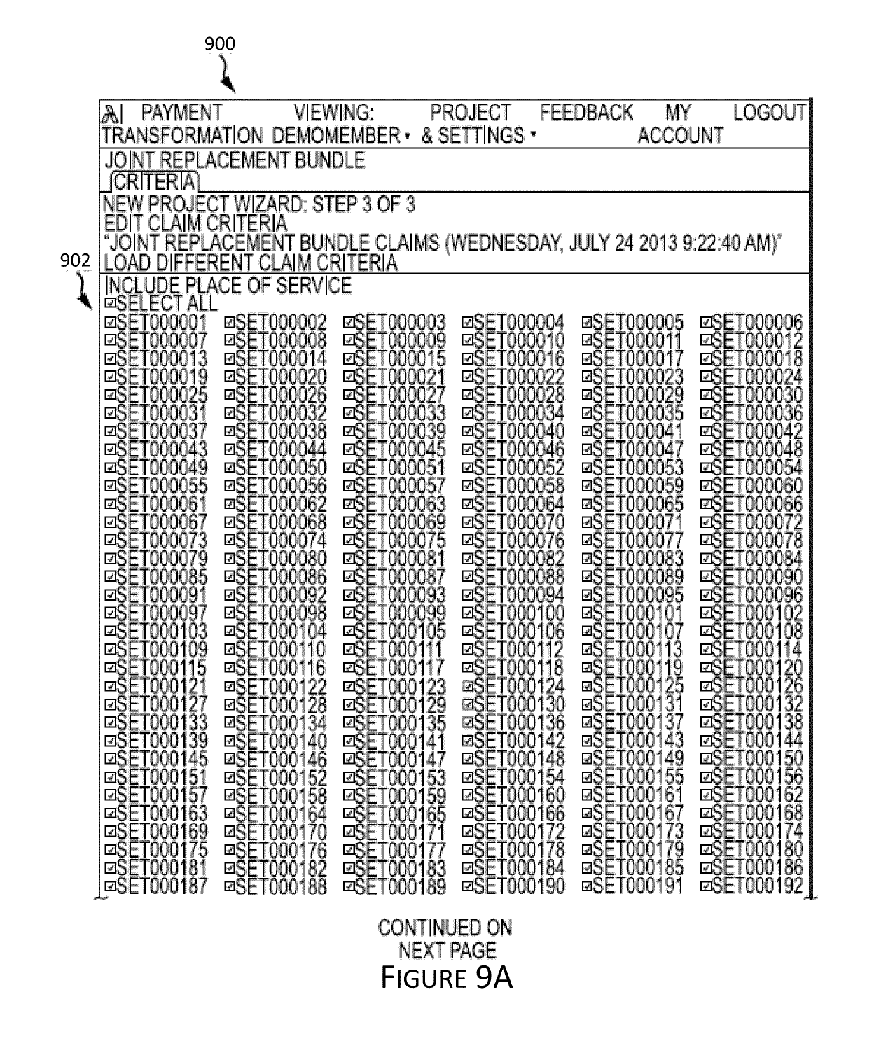

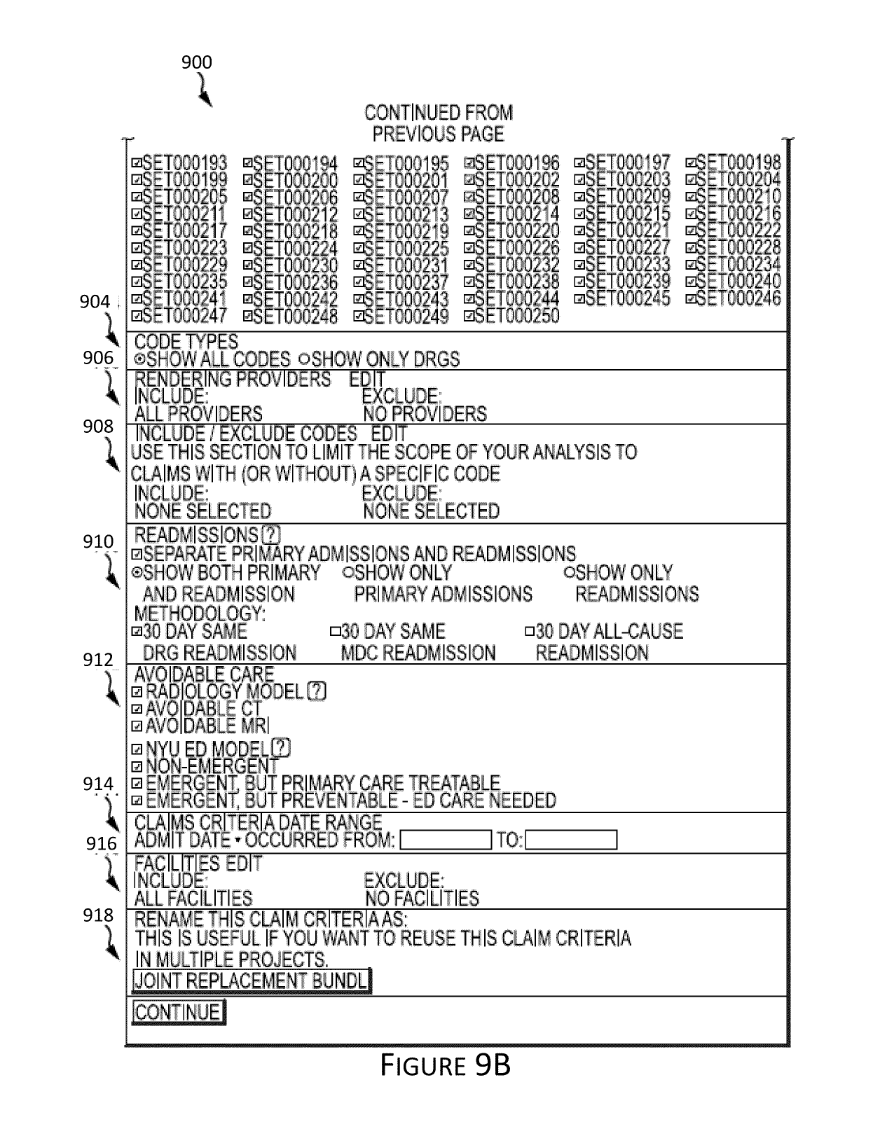

FIGS. 9A and 9B illustrate an exemplary embodiment of a claim criteria UI 900. The claim criteria UI 900 may allow a user to select specific claim criteria to include in the MDQ. In embodiments, claim criteria may relate to claims made to a payer or provider. Claim criteria UI 900 may include a place of service section 902, a code type section 904, a providers section 906, an included/excluded codes section 908, readmissions section 910, an avoidable care section 912, a date range section 914, a facilities section 916, and a naming section 918. In this example, claim criteria is a dimension and elements 902, 904, 906, 908, 910, 912, 914, and 916 allow a user to define factors for the claim criteria dimension in a MDQ.

The place of service section 902 allows the user to select specific places of service to include in the MDQ. A place of service may be a department, building, grouping, etc. In embodiments, a place of service may be defined by a specific healthcare facility. For example, a place of service may be a radiology department, a cardiac group, etc. Code type section 904 allows the user to limit the MDQ results to different types of codes. For example, the codes may be limited to DRG codes or may include all code types. Include/Exclude code section 908 allows the user to define different codes to include or exclude from the claims. For example, the codes may be included or excluded via interaction with a user interface like the one described with respect to FIG. 6. Readmissions section allows a user to select whether to show readmissions as well as primary admission claims. In embodiments, the user can select to show only primary admissions, only readmissions, or both. The readmissions may also be defined as only readmissions related to the same DRG code, readmissions related to the same major diagnostic categories (MDC) code, or any type of readmissions for the patient.

Avoidable care section 912 may allow the user to select whether to determine if any of the claims relate to avoidable care. In embodiments, upon the user's selection to include information about avoidable care, an algorithm may be employed on the MDQ results to determine whether any of the care could have been avoided by providing better treatment or keeping the patient in the healthcare facility for longer. For example, an algorithm may be employed to determine whether there were any avoidable radiology procedures, such as avoidable MRIs or CTs. In embodiments, the NYU Classification System for ED visits may also be employed to identify avoidable care such as non-emergent care, emergent care that could have been treatable with primary care, or emergent care that was preventable. In embodiments, the avoidable care algorithms may determine follow up items that are generally unnecessary, thereby allowing a healthcare administrator to identify areas where avoidable care is common and implement changes to practices to decrease the amount of avoidable care.

Date range section 914 may allow a user to define a date range for the claims to include in the MDQ. The date range may be based around different types of events. For example, the date range may be based around an admission date (e.g., when the patient was admitted to the facility), an event date (e.g., when the patient experienced an event, such as a heart attack), or any other type of event. The facilities section 916 may allow the user to select specific facilities, e.g., a specific hospital, to include or exclude. Naming section 918 may allow a user to provide a specific name for the trigger event criteria. In embodiments, this allows the user to reuse the defined claims criteria in multiple projects without having to redefine the criteria for each project.

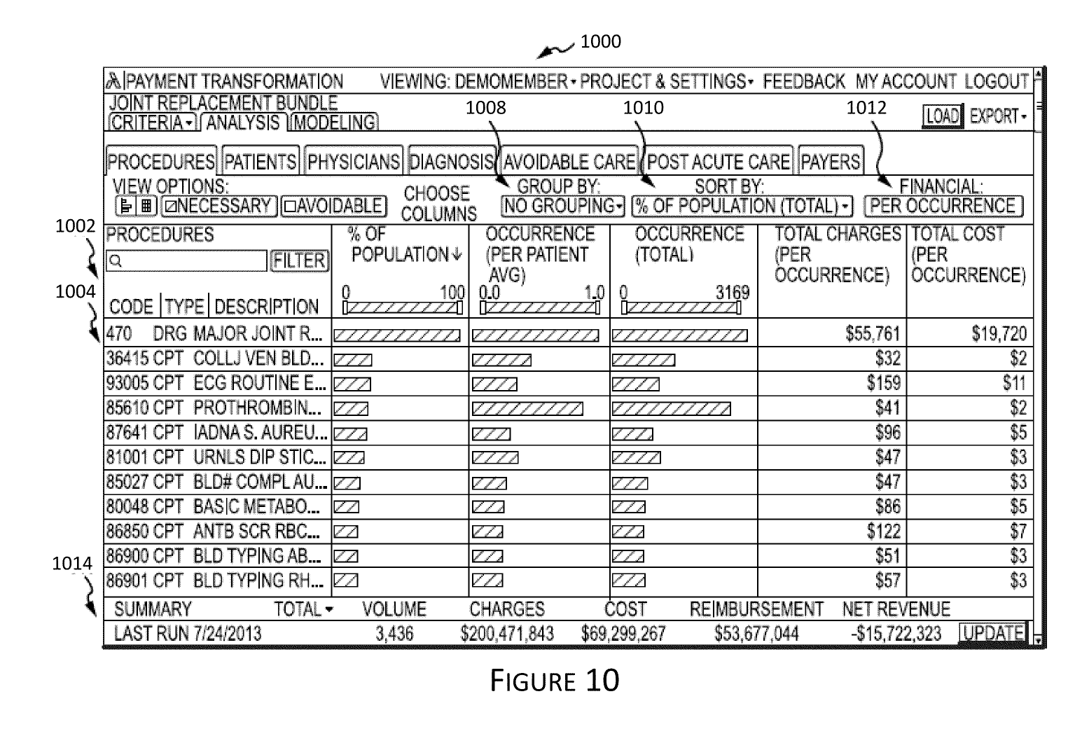

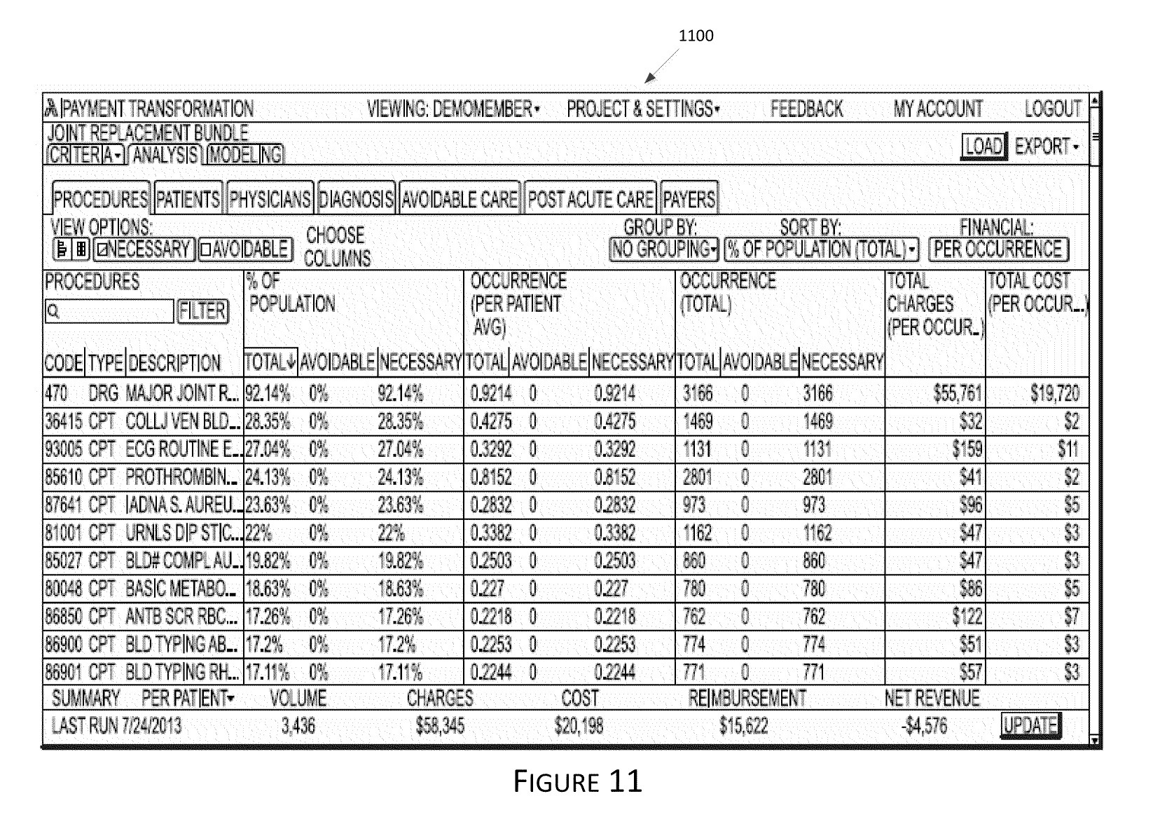

FIGS. 6-9 provide exemplary user interfaces that allow a user to define criteria for one or more factors related to a MDQ. Upon receiving the factors, the embodiments disclosed herein may perform the MDQ on institutional data to return the query results. The disclosure will now describe various user interfaces that may be used to display query results to a user. FIG. 10 is an embodiment of a procedures UI 1000 that displays results information according to the type of procedure performed. In this example, for the population defined by the MDQ, UI 1000 provides a view of all procedures meeting the requirements defined by the MDQ. In embodiments, procedures UI 1000 provides different view options such as a graphical view (illustrated in FIG. 10) or a numerical view 1100 (illustrated in FIG. 11). In embodiments, a numerical view 1100 may provide additional space on the screen to include additional information, such as the actual number of avoidable and necessary procedures. In embodiments, the procedure may also be classified as necessary or avoidable. The provider UI 1000 may distinguish the different type of procedures by displaying them in a different color, using a different pattern, or using any other type of visual indication.

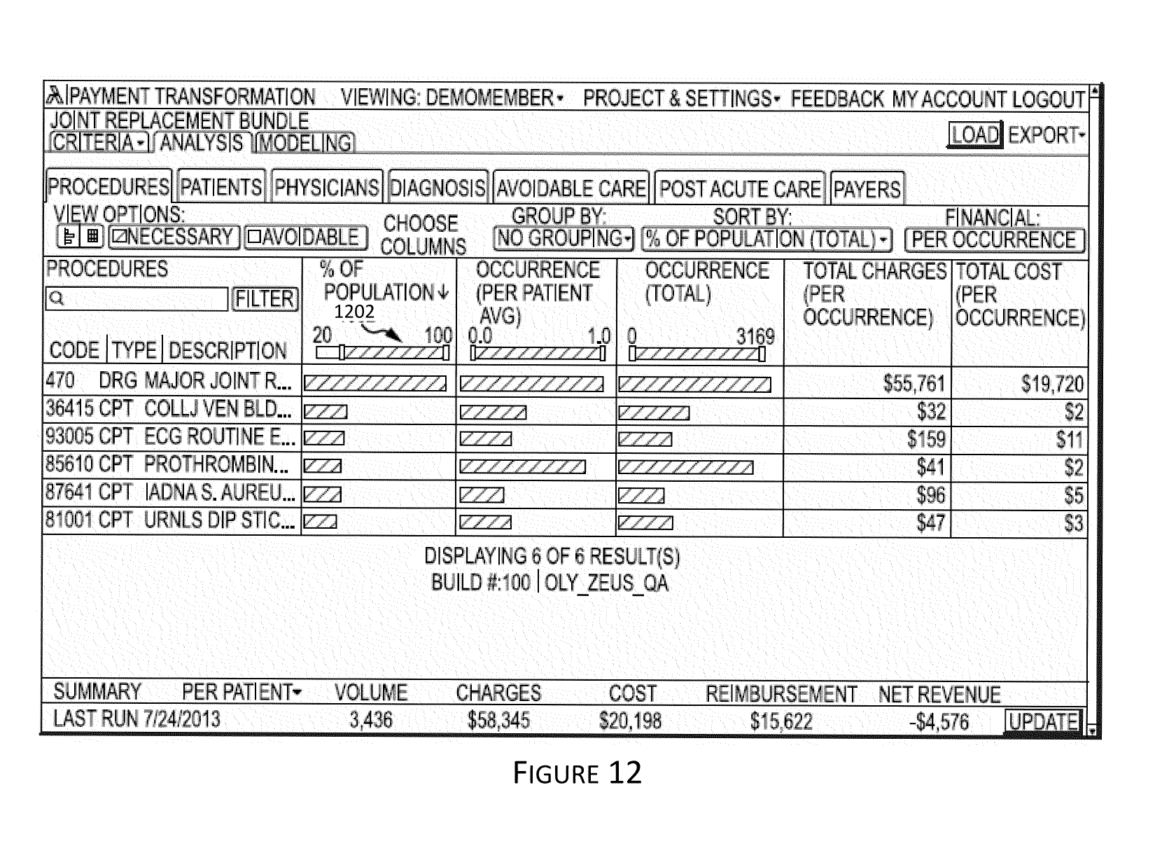

Procedures UI 1000 may return procedure results in a table format. The table may include a header row 1002 that identifies the procedures by different code, type, description, the percentage of the population affected by the procedure, the number of occurrences of the procedure per patient average, the total number of occurrences of the procedure, the total charges of the procedure, and the total cost of performing the procedure incurred by the health care facility. A user may interact with the header row 1002 in various ways. For example, a user can filter for a specific code or procedure by entering the code into a search box, can filter the numerical results by adjusting the graphical slide elements such as element 1006 (further illustrated in FIG. 12 with adjusted slide element 1202), or sort the results by ascending or descending values. Slide element 1202 allows the user to define the band of information to display. For example, the lower band of slide element 1202 has been moved from zero in FIGS. 10 to 20% in FIG. 12, thereby excluding from display results that otherwise meet the requirements of the MDQ. In this example, below the header row 1002, the individual procedures that were identified by the MDQ query are provided, such as the procedure identified in row 1004.

Procedure UI 1000 may also include additional UI elements that allow the user to further refine the results. For example, a group by element 1008 may allow the user to select different groupings for the results (e.g., by code, type, location, etc.). A sort by element 1010 may allow the user to select different ways of sorting the data. A financial element 1012 may allow the user to select how financial results are displayed, grouped, or determined. Finally, in embodiments the procedures UI 1000 may include a summary row 1014 that provides an overview of the procedures identified by the MDQ. In embodiments, the summary row 1014 may provide information related to the number of procedures identified, the total charges for the procedures, the total costs of the procedures, the total reimbursement value received for the procedures, and the net revenue made or lost on the set of procedures included in the population identified by the MDQ.

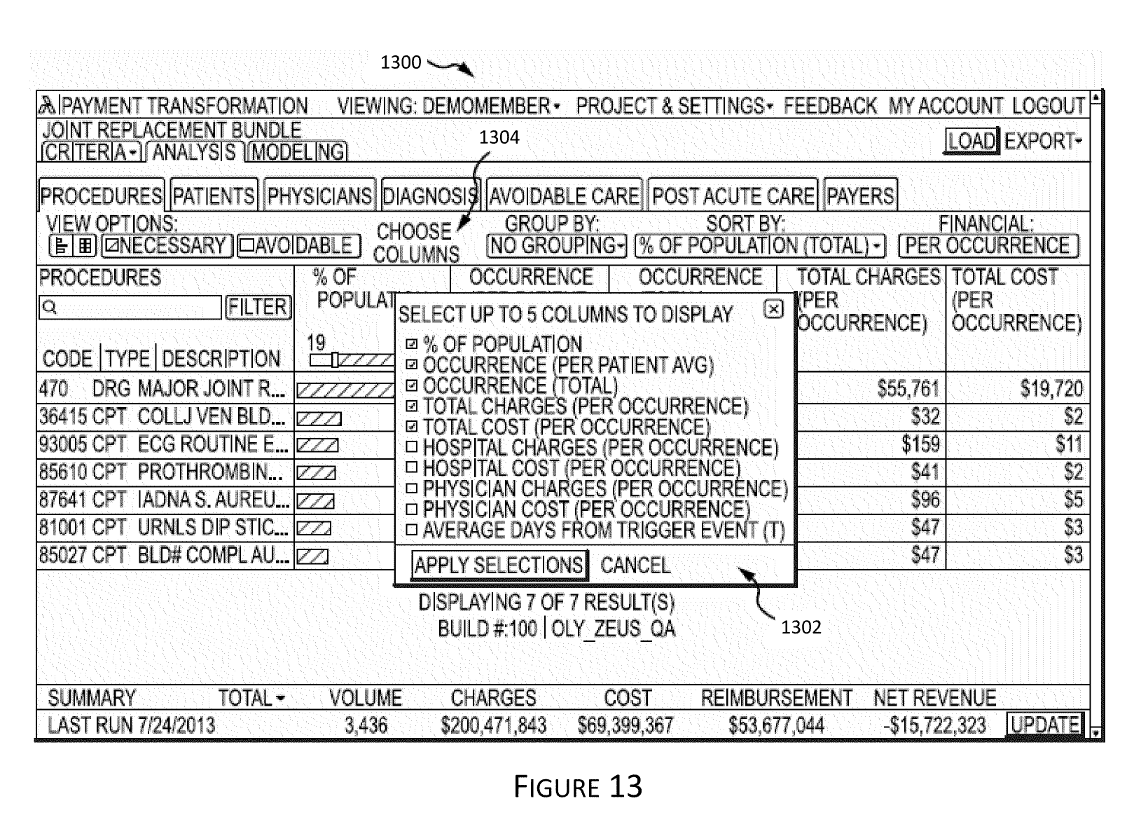

In embodiments, the Procedure UI 1000 may be customized by a user to display particular types of data in the results table. For example, FIG. 13 illustrates an exemplary user interface 1300 having a pop-up element 1302 that may be displayed in response to a user selecting the “Choose Columns” element 1304. The pop-up element 1302 may be used to allow a user to select the type of data to include in (or excluded from) the result table.

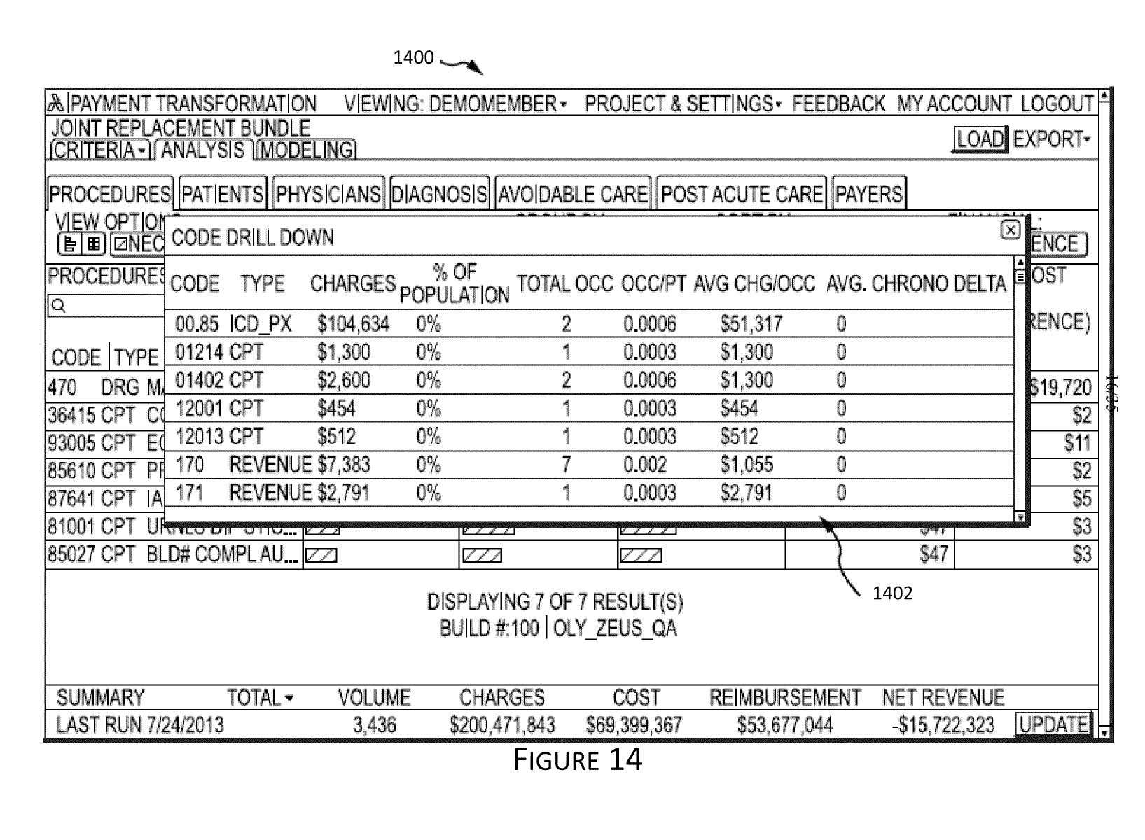

Embodiments disclosed herein provide the ability to drill down into specific data. For example, FIG. 14 provides an exemplary user interface 1400 that allows a user to select specific codes from the procedure UI and to display detailed information about those codes. In the illustrated embodiment, the detailed information may be displayed in a pop up element 1402 that provides specific information about each code identified in the procedure UI.

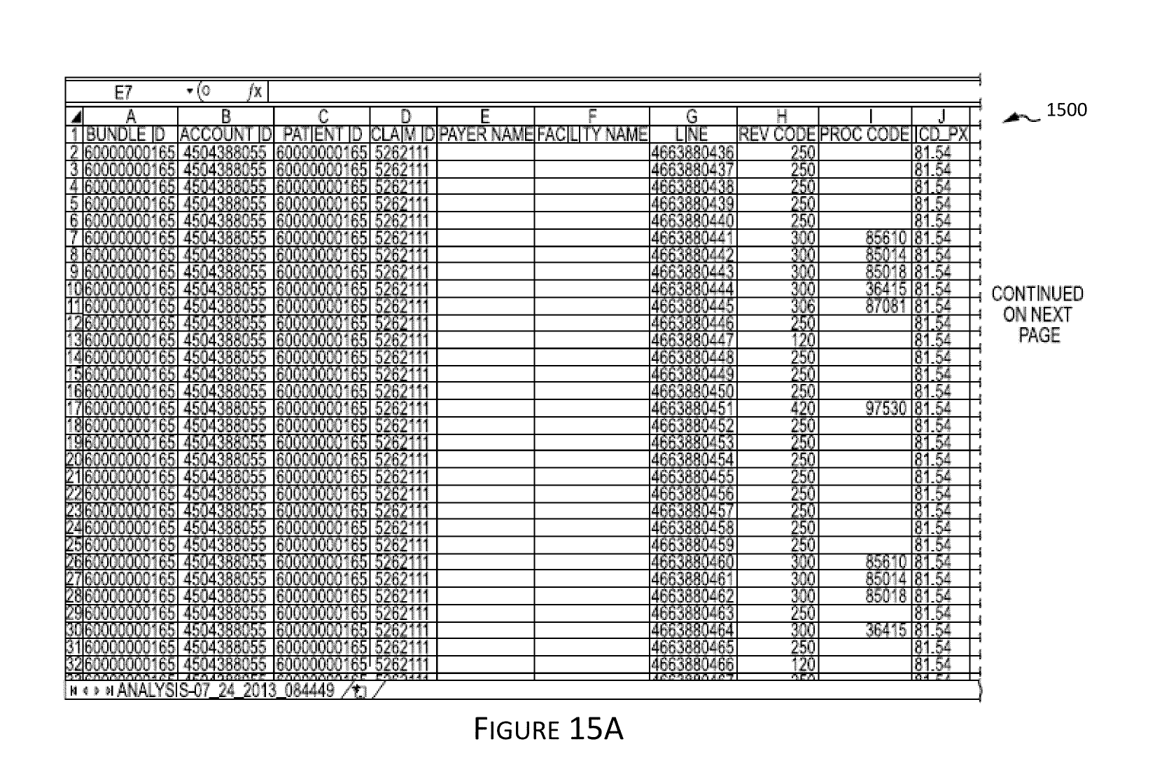

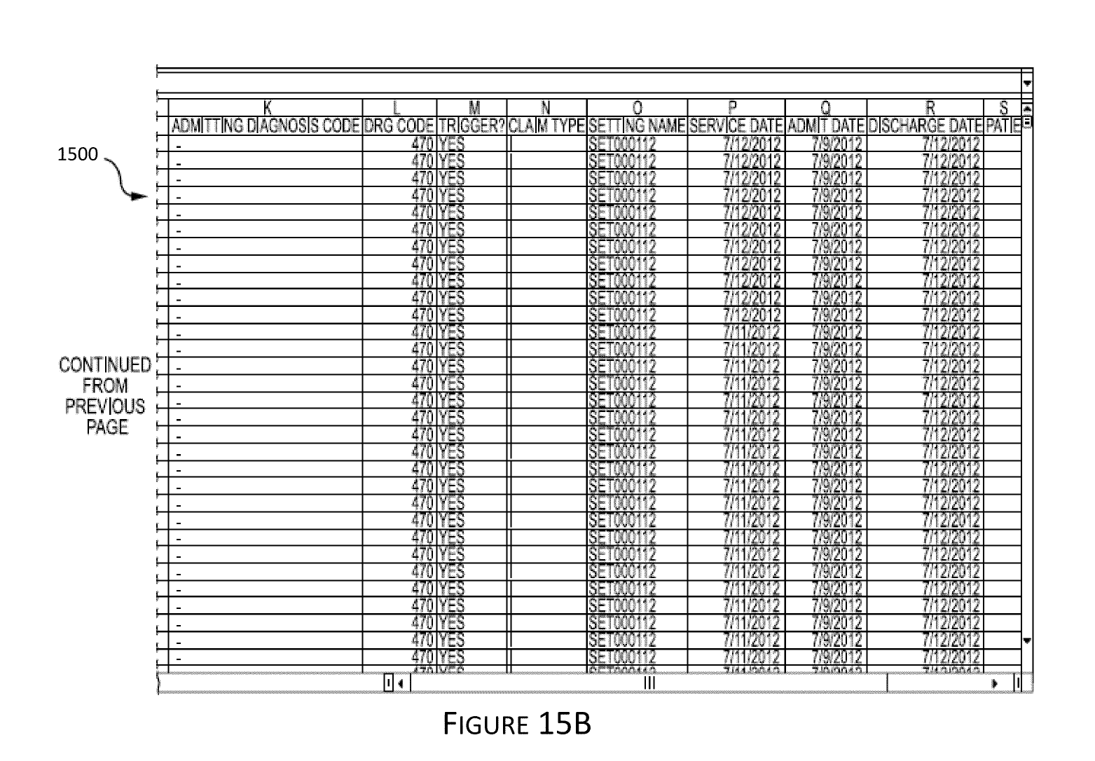

In further embodiments, the data may be provided in various different formats. For example, a user can select the “Export” element from the procedure screen. In embodiments, the “Export” element may allow a user to export the data from the exemplary table into another format, such as a spreadsheet 1500, as illustrated in FIGS. 15A and 15B. In embodiments, the query results may be exported to a different format that can be used by another application, stored offline, or be in a form that the user prefers. While spreadsheet 1500 depicts specific information that is included in the spreadsheet, in alternate embodiments, a user may specify which fields to include in the spreadsheet 1500.

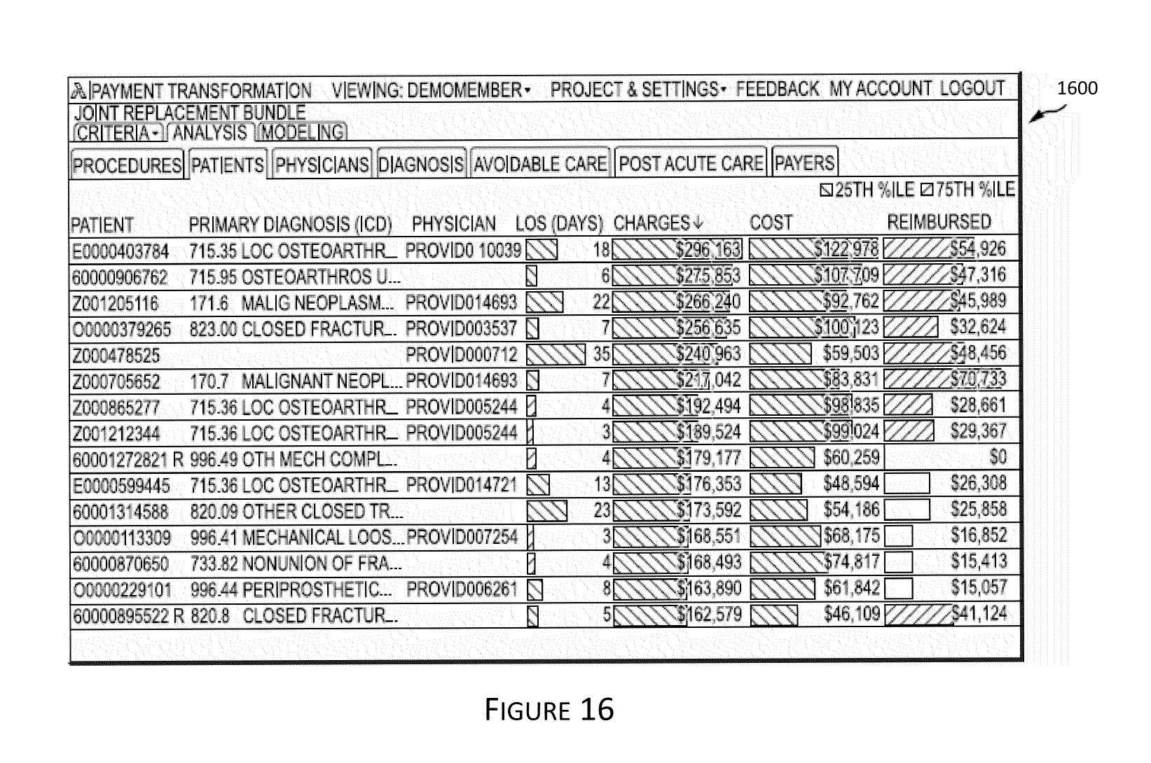

FIG. 16 illustrates a patient UI 1600 that may be displayed upon selection of the “Patients” tab. In embodiments, the patient UI 1600 may organize MDQ results according to patient. In embodiments, the patient UI 1600 may identify a patient, the primary diagnosis, the patient's physician, the patient's length of stay, the charges made to the patient, the cost incurred by the healthcare provider for the patient, and the reimbursement for the patient. In embodiments, the data may be sorted and filtered as described with respect to the procedure UI. In further embodiments, graphical indications (e.g., colors, textures, patterns, etc.) may be employed to provide additional comparison information about how the particular patient's data relates to the general patient population for the facility.

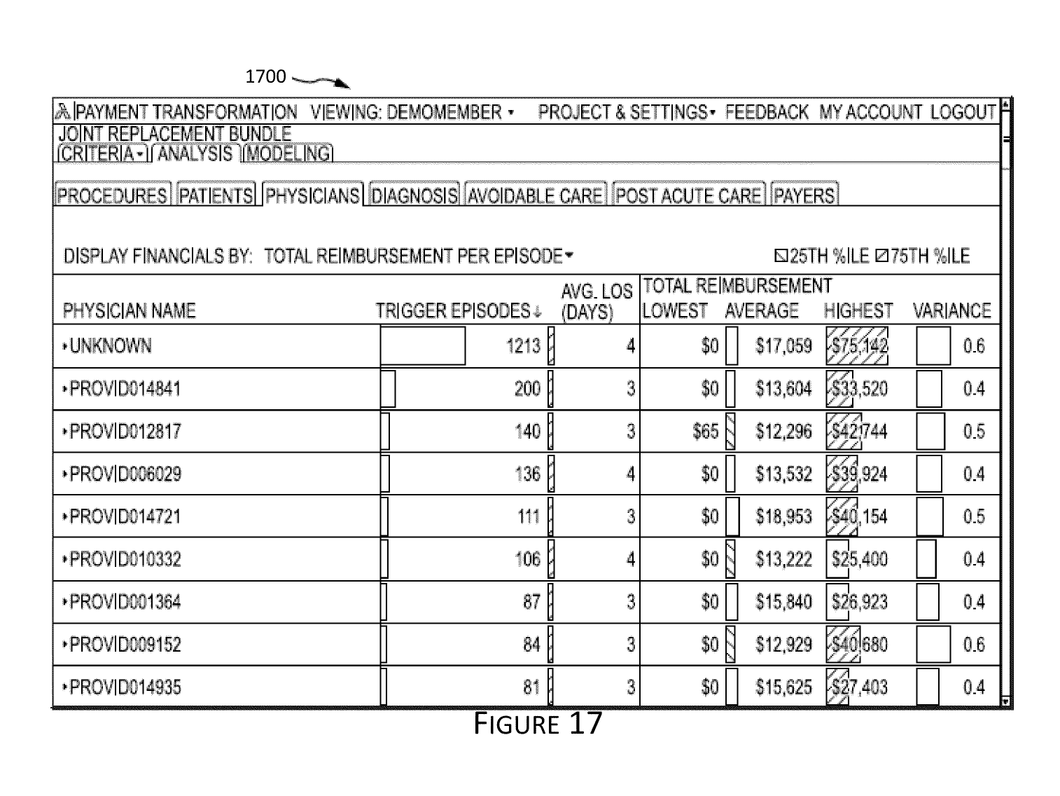

FIG. 17 illustrates a physician UI 1700 that may be displayed upon selection of the “Physicians” tab. In embodiments, the physicians UI 1700 organizes MDQ results based on an individual physician. In embodiments, the physician UI 1700 may display information about each individual physician that includes the number of triggering episodes per physician, the average length of stay for the physician's patients, and reimbursement information on a physician by physician basis. In embodiments, the data may be sorted and filtered as described with respect to the procedure UI. In further embodiments, graphical indications (e.g., colors, textures, patterns, etc.) may be employed to provide additional comparison information about how the particular physician's data relates to the general physician population for the facility. The physician information allows an administrator to evaluate the performance of each physician and identify which physicians performance needs improvement to more efficiently provide service to patients.

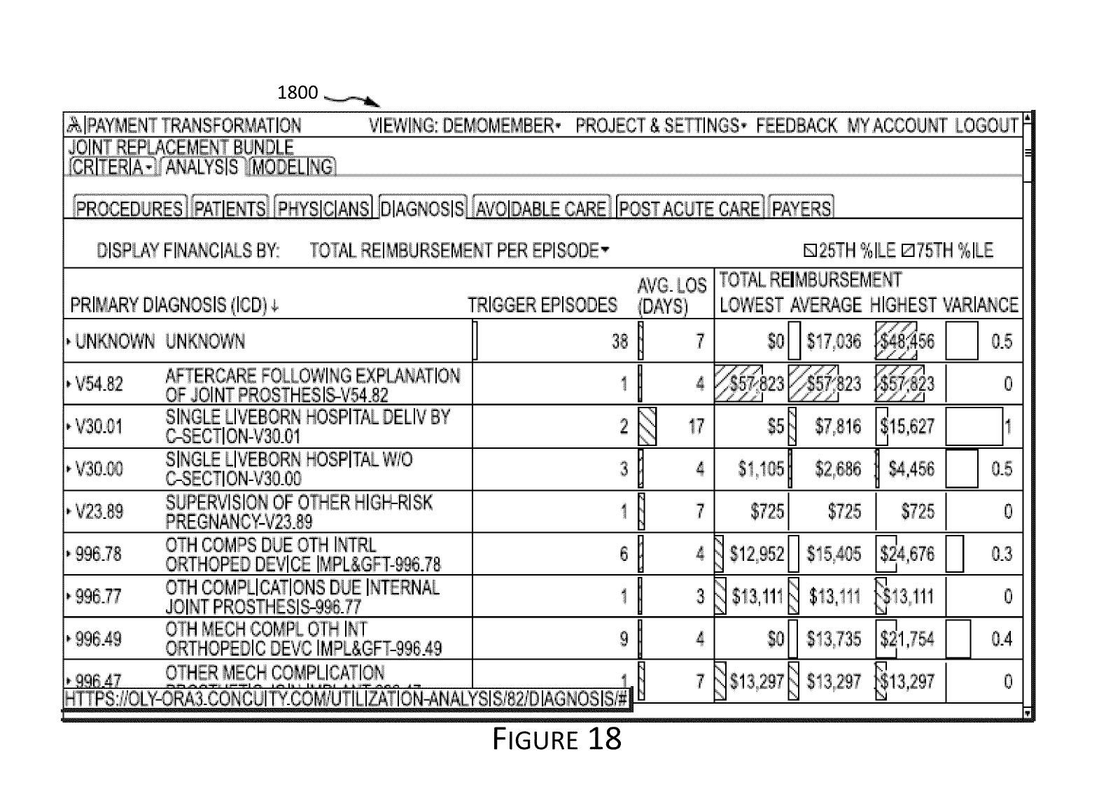

FIG. 18 illustrates a diagnosis UI 1800 that may be displayed upon selection of the “Diagnosis” tab. In embodiments, the diagnosis UI 1800 organizes MDQ results on a diagnosis by diagnosis basis. In embodiments, the data may be sorted as described with respect to the procedure UI. In further embodiments, graphical indications (e.g., colors, textures, patterns, etc.) may be employed to provide additional comparison information about how the particular patient's data relates to the other diagnoses treated by the facility. The diagnosis UI 1800 provides information that allows an administrator to identify specific areas where the healthcare facility is not performing well and, therefore, can identify areas where better procedures may be needed by the facility or where reimbursement contracts may need renegotiation.

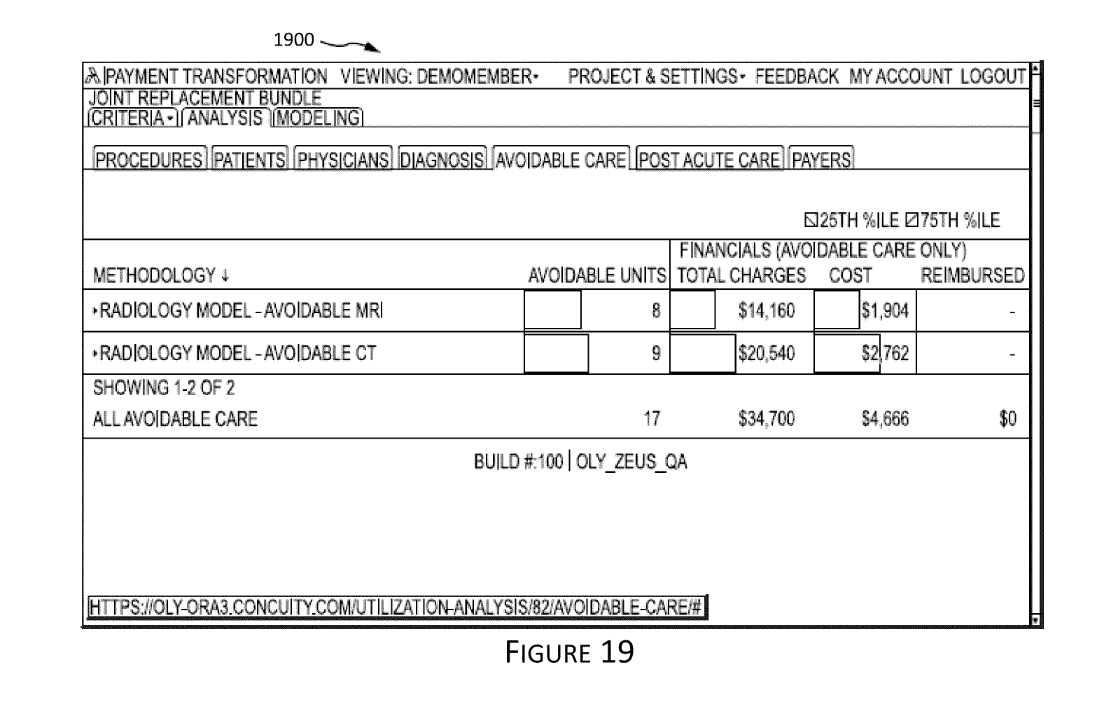

FIG. 19 is an embodiment of an avoidable care UI 1900 that may be displayed upon selection of the “Avoidable Care” tab. In embodiments, the avoidable care UI 1900 displays, for the population identified by the MDQ, information about the costs that the institution incurs due to providing avoidable care. In embodiments, the data may be sorted as described with respect to the procedure UI. In further embodiments, graphical indications (e.g., colors, textures, patterns, etc.) may be employed to provide additional comparison information.

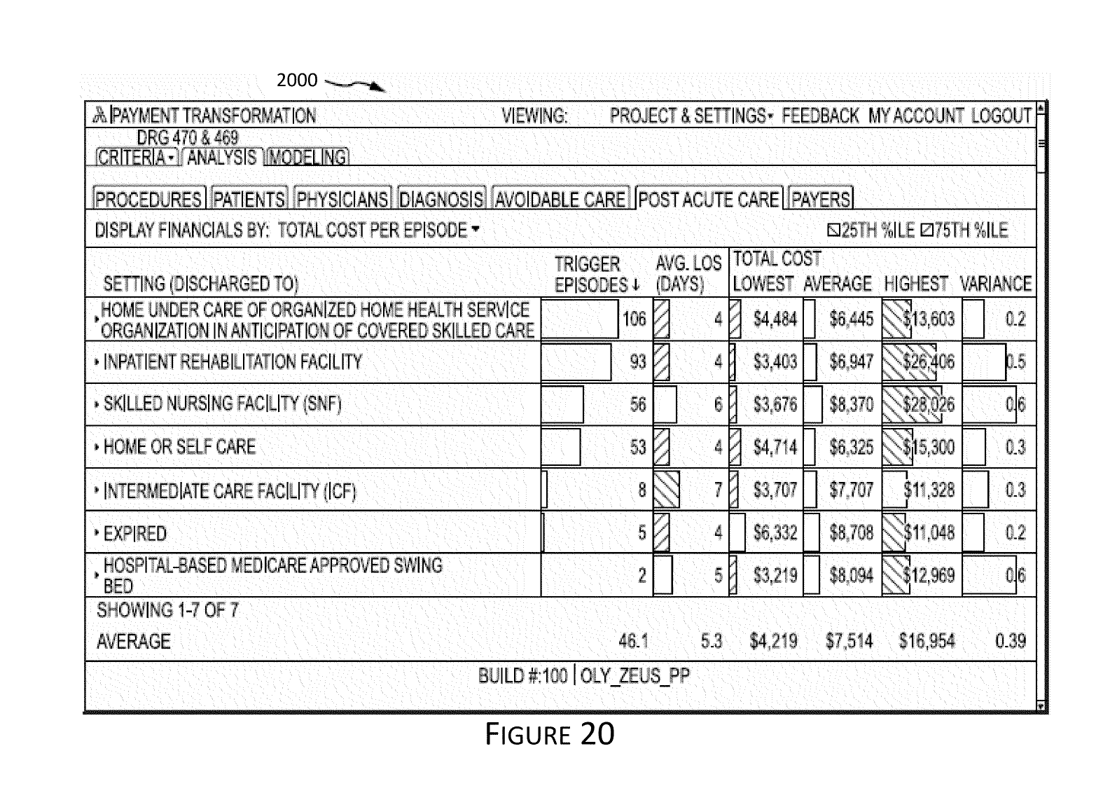

FIG. 20 is an embodiment of a post-acute care UI 2000 that provides MDQ results based upon where a patient received post-acute care. In embodiments, the post-acute care UI 2000 organizes information as to where the patient received follow up care after a procedure was performed (e.g., at the healthcare facility, was discharged to home, at a nursing home, etc.). In embodiments, the data may be sorted as described with respect to the procedure UI. In further embodiments, graphical indications (e.g., colors, textures, patterns, etc.) may be employed to provide additional comparison information. In embodiments, the post-acute care UI 2000 provides information that allows an administrator to determine the most cost effective post care facility for patients based on procedure or other factors. In additional embodiments, acute care may be organized by the facility a claim originated from.

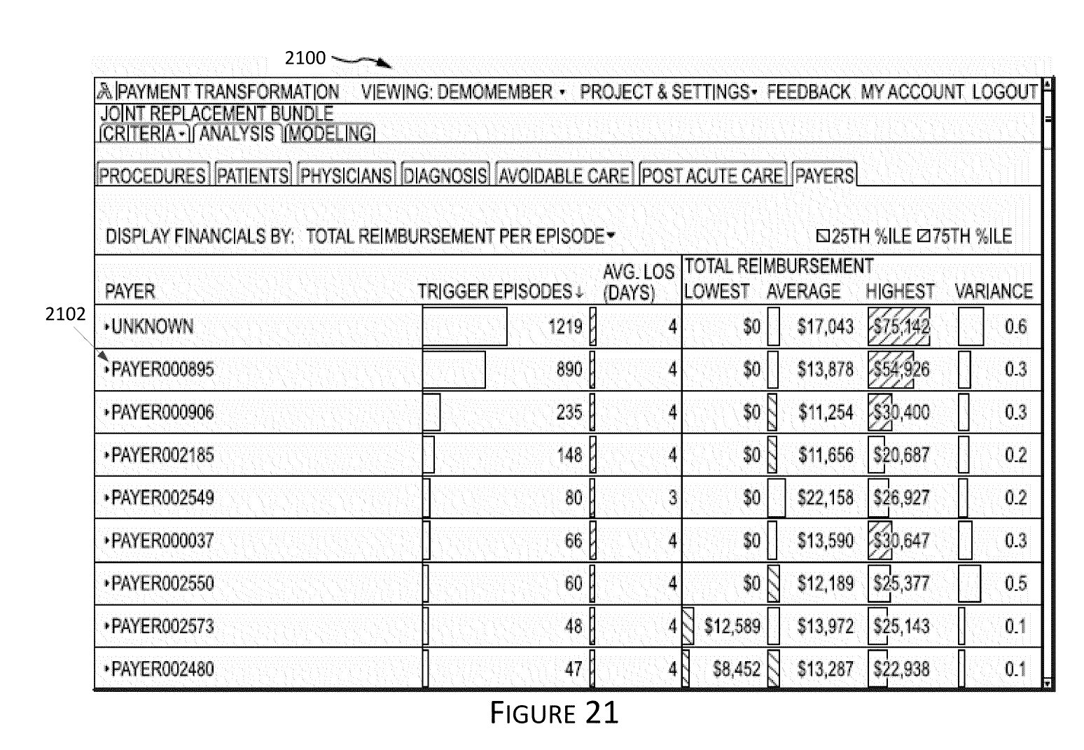

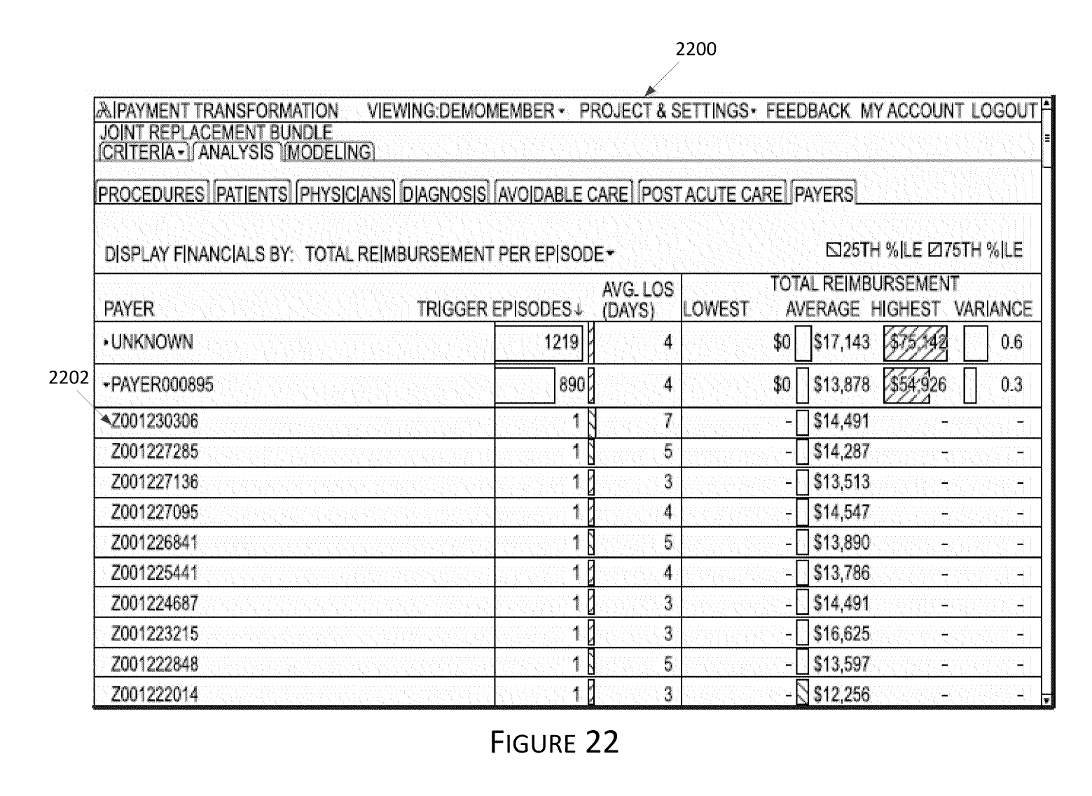

FIG. 21 is an embodiment of a payers UI 2100 that may be displayed upon selection of the “Payers” tab. In embodiments, the payers UI 2100 organizes MDQ results based upon specific payers (e.g., insurance providers, plans, individuals, government, etc.). In embodiments, the data may be sorted as described with respect to the procedure UI. In further embodiments, graphical indications (e.g., colors, textures, patterns, etc.) may be employed to provide additional comparison information. In embodiments, the payers UI 2100 provides information that an administrator can use to determine which payer contracts may need to be renegotiated. For example, each row in payers UI 2100 represents information for all cases related to specific payer (e.g., row 2102 represents all identified payments for “PAYER00895”). In embodiments, the information in the payers tab can be drilled down to describe payments on a patient by patient basis, as is illustrated in user interface 2200 of FIG. 22. For example, row 2202 provides information about a specific patient (identified as “Z001230306”). The drilled down view of user interface 2200 may be displayed upon selection of “PAYER00895” from row 2102 of FIG. 21.

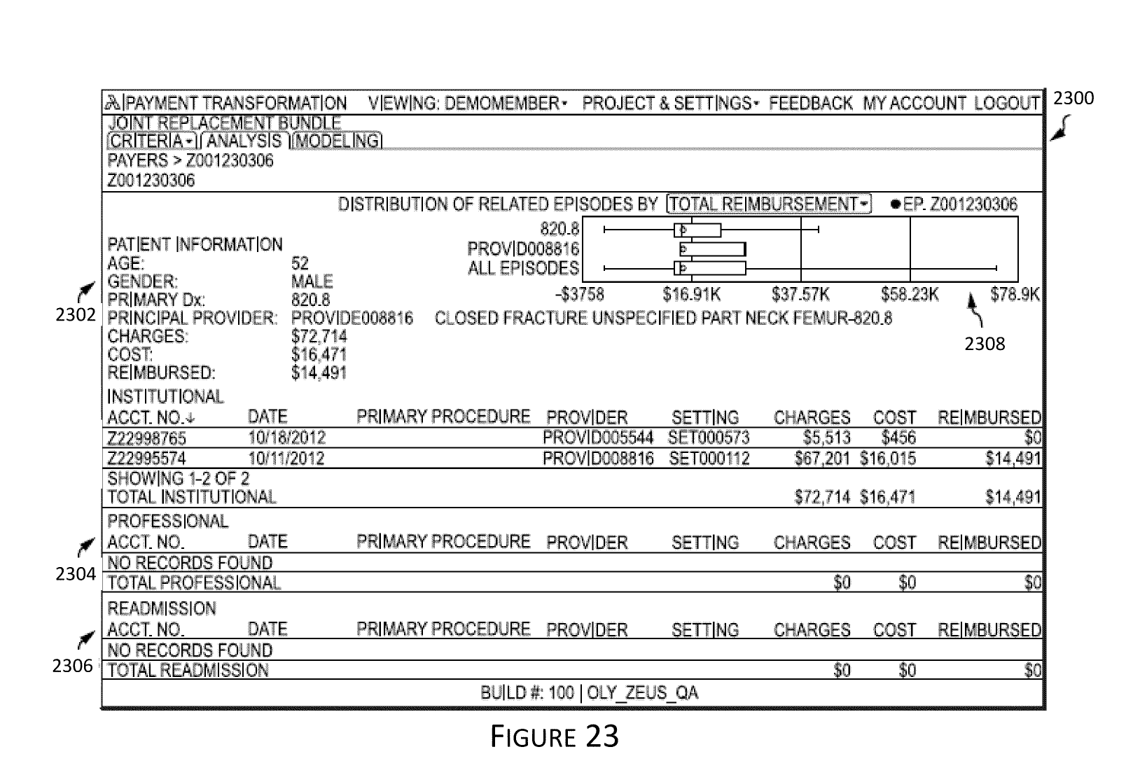

FIG. 23 is an embodiment of a patient detail UI 2300 that provides detailed information about a specific patient included in the MDQ results. Patient detail UI 2300 may include a patient information section 2302 that displays information about the specific patient. Patient detail UI 2300 may also include an institutional section that displays patient information based on the different institutions that serviced the patient, a profession section 2304 that displays information about the professionals (e.g., doctors, nurses, etc.) that provided service to the patient, and a readmission section 2306 that provides information readmission information about the specific patient. In embodiments, the patient detail UI 2300 may also include a distribution graph 2308 that provides a comparison of metrics related to the selected patient against average metrics or performance for specific code, procedure, provider, etc. compares to other patients.

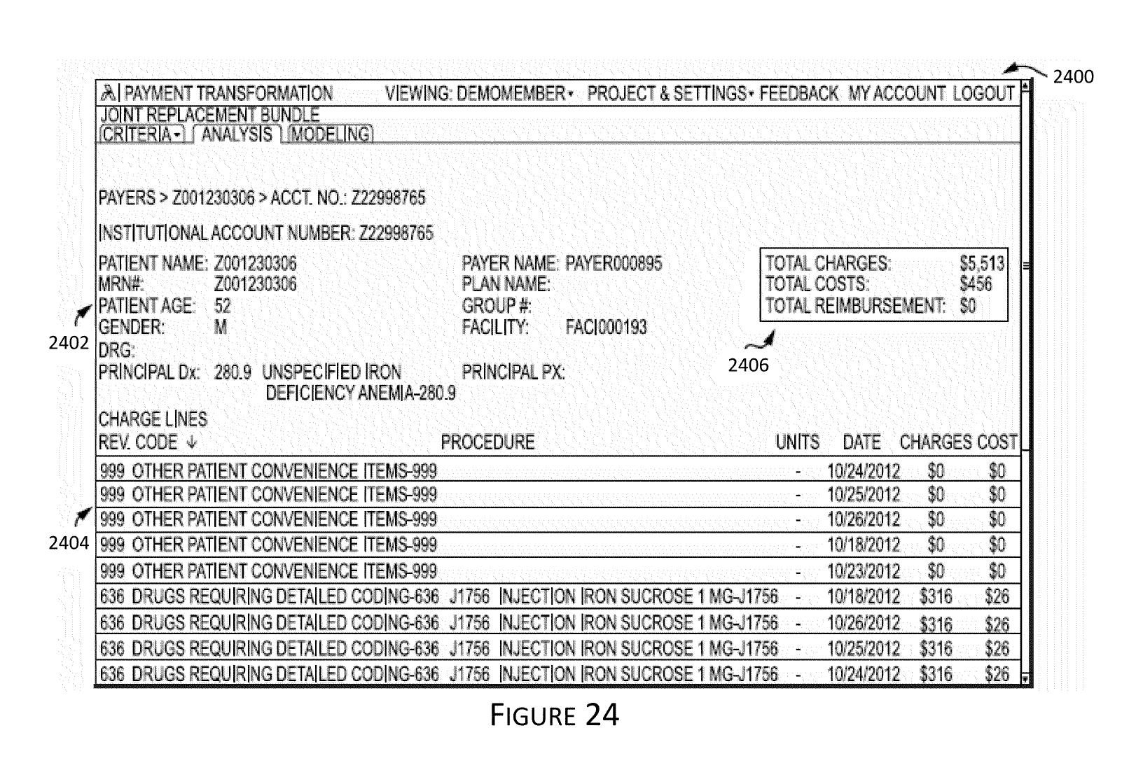

FIG. 24 illustrates an embodiment of a claim detail UI 2400 that provides detailed information about a claim in the MDQ results. Claim detail UI 2400 may comprise an information section 2402 that includes information about the claim (e.g., patient information, institution information, etc.), a charges section 2404 that outlines line item charges for the claim, and a summary section 2406 that provides total charges, costs, and reimbursement for the claim. In further embodiments, the claims detail information may be displayed such that it includes information about a professional involved with the claim (e.g., a doctor, surgeon, nurse, etc.).

Having described various different user interfaces for organizing and displaying MDQ results, the disclosure will now turn to user interfaces that may be used to provide modeling functionality. In embodiments, a user may be able to adjust different parameters (e.g., costs, charges, reimbursement, readmission rates, mortality rates, etc.) to determine how the changes will affect the operating efficiency of the institution. In embodiments, the changes represented by the predictive model created according to the adjustments may be simultaneously displayed against the metrics from the baseline model. For example, a summary of the financial metrics for the predictive model and the baseline model may be simultaneously displayed, thereby making it easy to compare changes that result based upon the received adjustment. The modeling user interfaces provide a powerful tool that helps determine how to adjust policies, procedures, or renegotiate contracts to provide more efficient operations, both fiscally and procedurally.

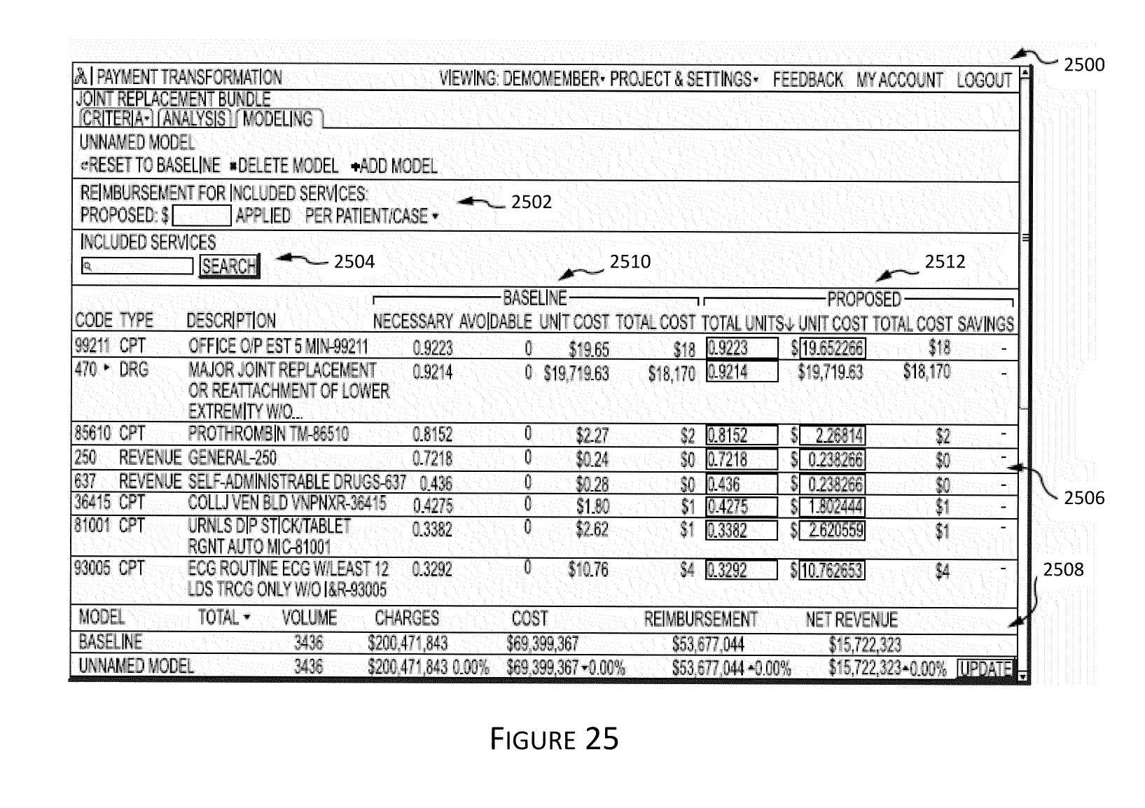

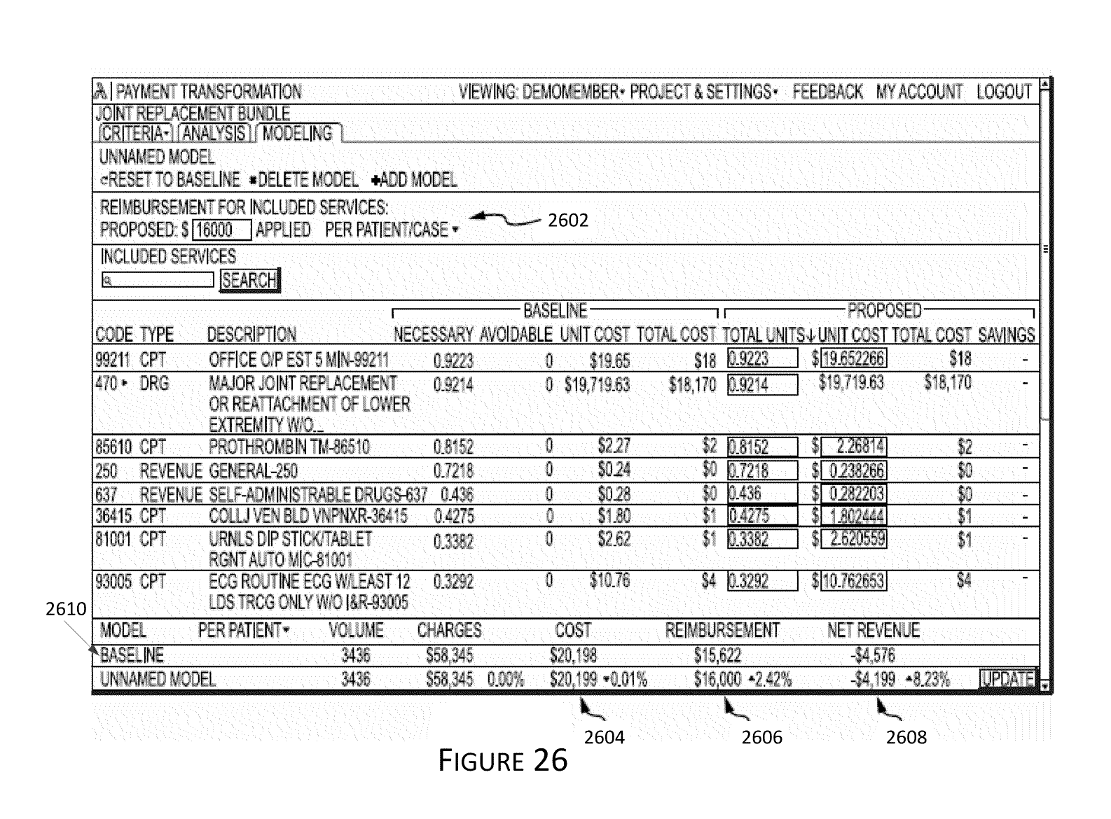

FIG. 25 is an embodiment of a modeling UI 2500 that allows a user to adjust various factors of a baseline model to create a predictive model that may be helpful in determining whether the changes provide a positive or negative financial effect for the population identified by the MDQ. In embodiments, the population may be based upon the MDQ result set produced by querying the historical data of the institution based upon a set of received dimensions and/or factors related to the dimensions. The determination may be based upon historical data of the institution. In embodiments, the baseline model may be adjusted on a claim basis, provider basis, physician basis, or any other type of basis. Modeling UI 2500 includes a reimbursement section that allows the user to define a proposed reimbursement amount. The proposed reimbursement may be per patient, per claim, etc. As illustrated in FIG. 26, when a user enters a proposed reimbursement (e.g., an adjustment parameter) amount into text box 2602, the embodiments disclosed herein recalculate costs, reimbursements, revenue, and/or margins using the historical information and display how the proposed reimbursement plan changes overall costs 2604, reimbursement, 2606, and net revenue 2608. In embodiments, the recalculation may include determining whether or not the received change is a vertical parameter (e.g., has an effect on a single vertical relationship) or a horizontal parameter (e.g., has an effect on multiple vertical relationships). In one embodiment, the recalculation may include making adjustments to the MDQ results set and/or identified population. For example, some of the historical data may be eliminated because the received adjustment parameters exclude those events. For example, if one of the adjustment parameter is a change in practice that eliminates a treatment, data and values related to the eliminated treatment may be removed from the population when generating the predictive model to recalculate. In other embodiments may include adjust values of derived from the historical data in a baseline model based on an average. For example, if the adjustment parameter related to a reduction in readmission by 20%, values for the proposed model may be recalculated by determining the total value of all costs and revenues related historically to readmissions and reduce those values by 20%. While specific examples of changes are described herein, one of skill in the art will appreciate that other changes may be employed to generate a predictive model and/or recalculate values based upon a proposed change. The summary of the financial metrics may be displayed in a summary ribbon 2610. The summary ribbon 2610 may simultaneously display the financial metrics of the baseline model and the predictive model.

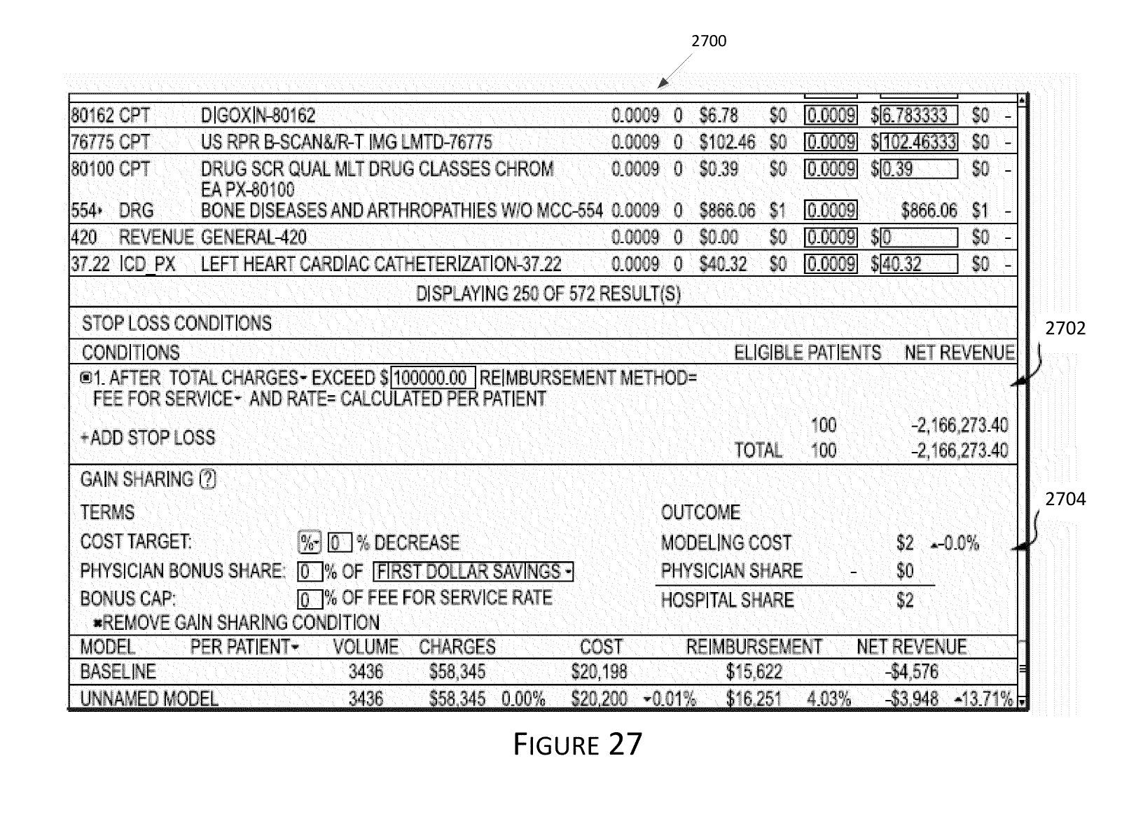

Referring back to FIG. 25, in the modeling UI 2500 may also include detailed information on costs related to specific codes or procedures, including a comparison of baseline costs 2510 and proposed costs 2512. In embodiments, a user can adjust the proposed costs 2512 which may result in generation of a new predictive model. Modeling UI 2500 also includes a summary section 2508 that provides overview data for baseline and predicted models. As illustrated in FIG. 27, the modeling UI 2700 may also include a stop loss section 2702 that allows a user to adjust different stop loss condition or gain sharing terms 2704 to determine how such changes affect the financial metrics for the predictive model versus the baseline model.

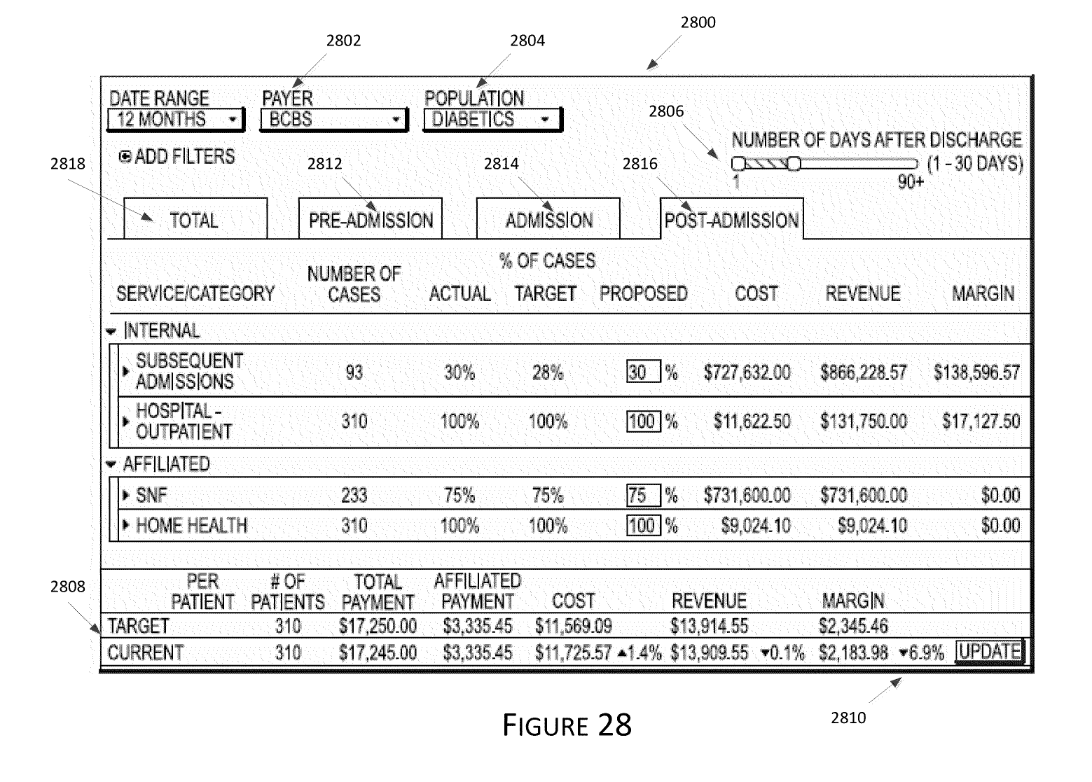

FIG. 28 illustrates an alternate embodiment of a financial metrics UI 2800 based upon post-admission procedures. The financial metrics UI 2800 may include a drop down menu 2802 that allows a user to quickly switch between payers. Additionally, a population drop down menu 2804 may be provided that allows a user to quickly change populations based upon a predefined population (e.g., diabetics, stroke victims, heart attack victims, etc.). Financial metrics UI 2800 may also include a slider bar 2806 that allows the user to adjust the window of time to include data in the post-admission metrics. Financial metrics UI 2800 may also include a summary ribbon 2808 that simultaneously displays the financial metrics of the baseline model (e.g., “Current”) and the predictive model (e.g., “Target”). In embodiments, a calculation of the differences between the models may also be performed. An indication of the differences 2810 between the models may be displayed in the summary ribbon 2802.

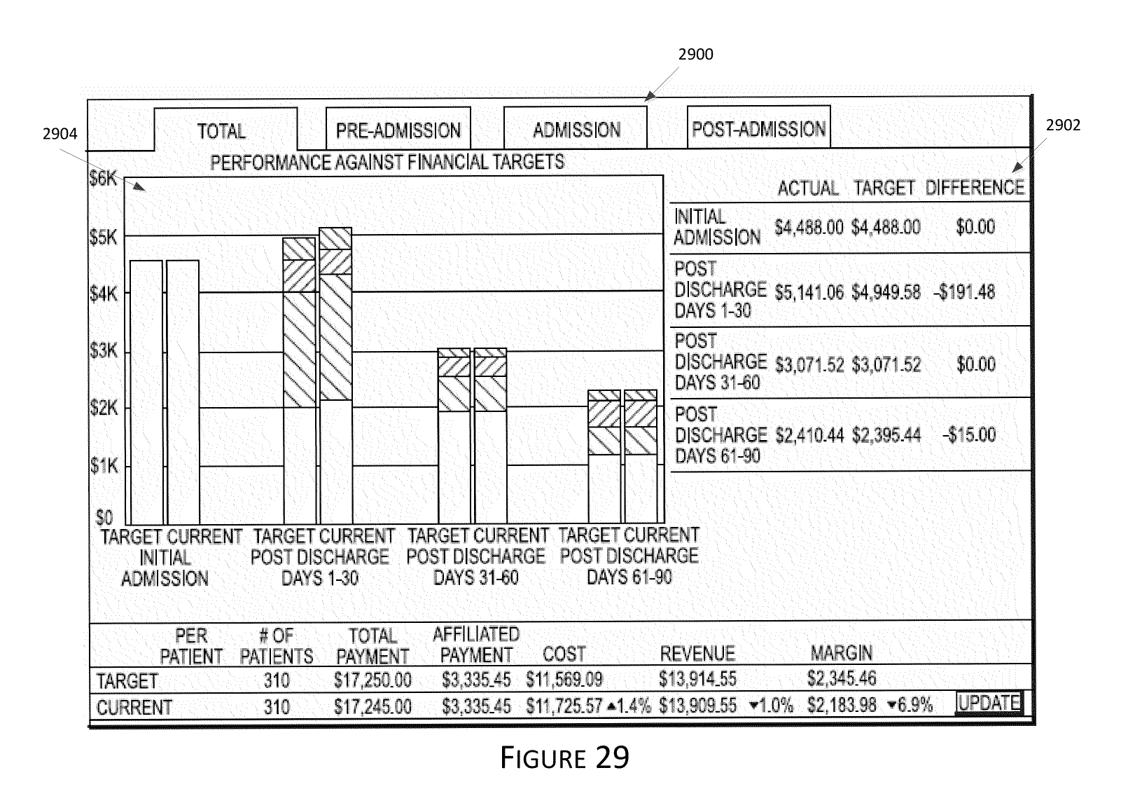

As illustrated in FIG. 28, the results of the modeling may be filtered by payer, by population, and/or by time. For example, financial metrics UI 2800 may include different tabs that allow a user to specify a specific time for the models. In the exemplary embodiment provides tabs for “Pre-Admission” 2812, “Admission” 2814, “Post-Admission” 2816 (which is selected in the illustrated embodiment), as well as a “Total” tab 2818 which accounts for data during pre-admission, admission, and post-admission. FIG. 29 illustrates an alternate view of a modeling UI 2900 that may be displayed in response to selection of the “Total” tab 2818. In embodiments, the modeling UI 2900 may include a table 2902 displaying the actual values as compared to target values. Additionally, a bar graph 2904 may be included to provide a visual display of the actual and target metrics. As illustrated in FIG. 29, in addition to modeling proposed contractual changes, the embodiments disclosed herein may be used to generate models that may be used to identify areas of a practice that may need changes in order to reach a desired level of performance.

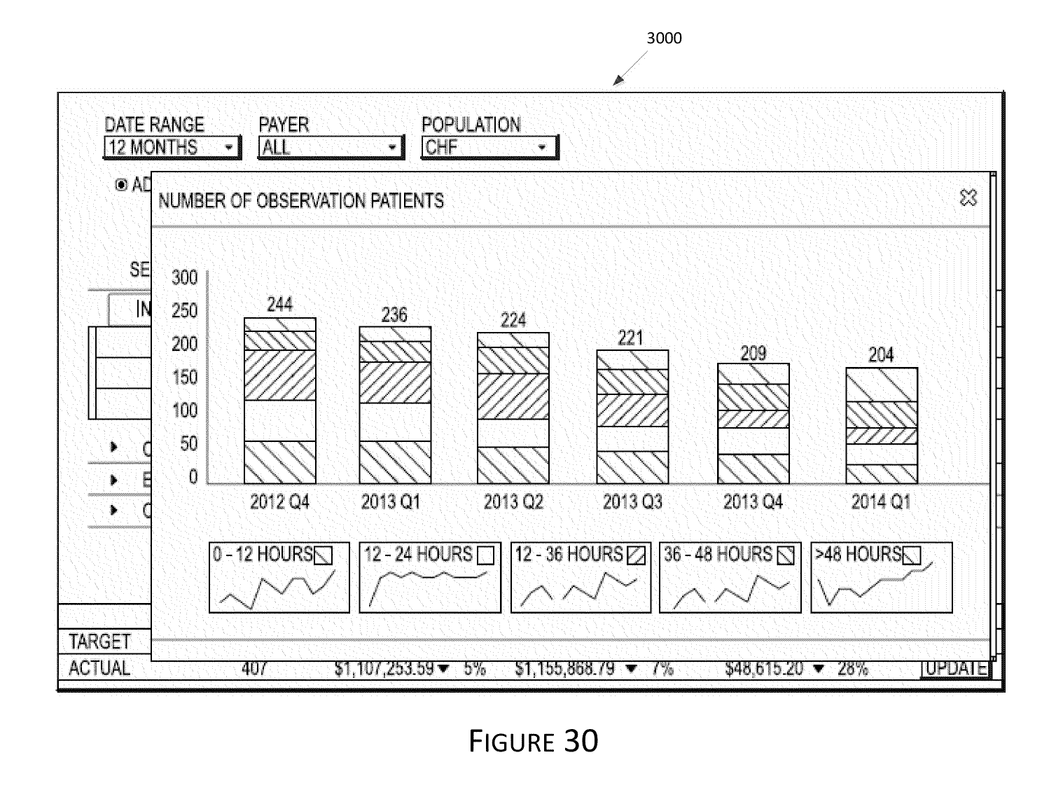

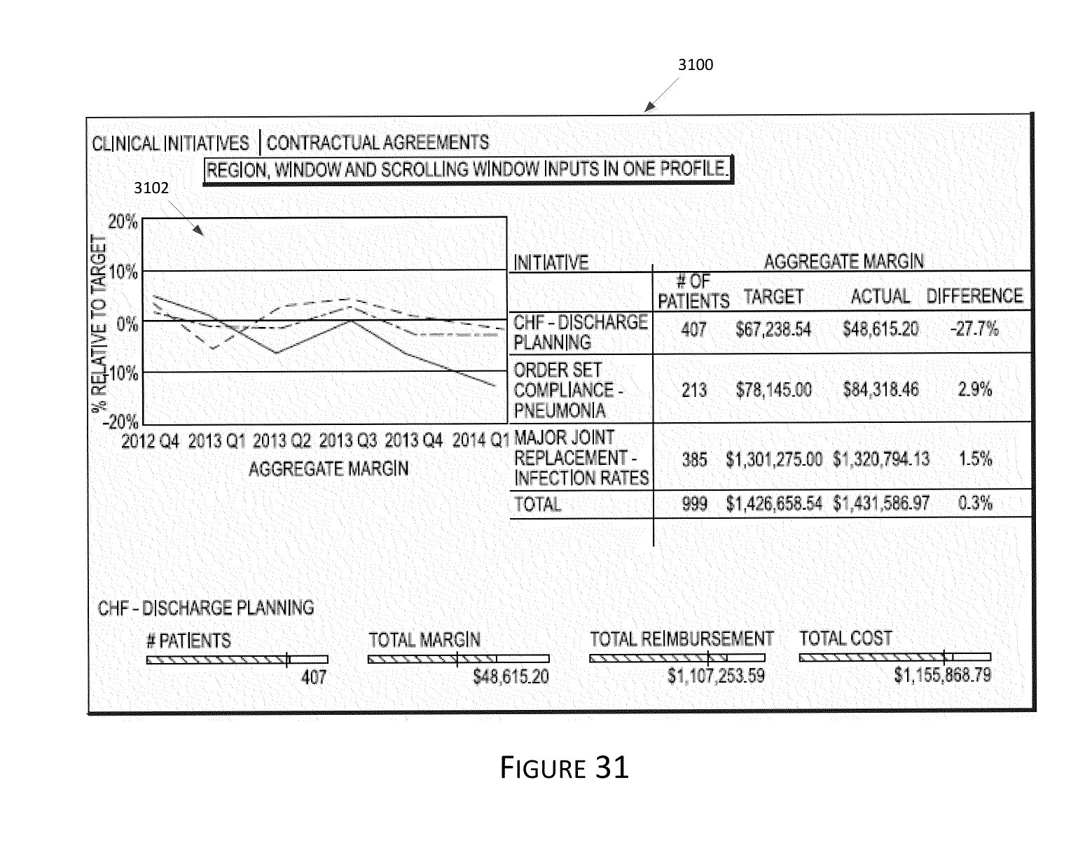

The embodiments disclosed herein may also leverage the aggregation of different data to provide overview information to a user. FIG. 30 illustrates an exemplary embodiment of an overview graph 3000 illustrating observation time for a particular population. FIG. 31 illustrates and alternate view 3100 displaying metrics that relate to a specific population over time. In embodiment, a graph 3102 may be presented that highlights actual performance against target performance. The information displayed in view 3100 may be used to identify areas of a practice that need improvement in order to reach a target level of performance.

In embodiments, more than one parameter may be simultaneously adjusted from the baseline model to create the predictive model. For example, an adjustment to the reimbursement amount for a particular procedure may be changed for one payer while also adjusting the readmission rate for patients of that procedure by a particular amount. This would allow a user, for example, to test the effect of getting increased fees from one payer for a particular procedure but on the condition that clinical changes are made to reduce the readmission rates for that procedure (which would affect revenues from other payers as well). This can be accomplished, for example, by altering the baseline model to generate the predictive model by: (1) for the affected payer, substituting the new reimbursement amount for all such procedures included in the MDQ results; and (2) for all payers, reducing all costs and revenues associated with procedures that are classified in the MDQ results as related to readmissions. The predictive model and its associated financial metrics may then be generated for the entire population identified by the MDQ. As such, the predictive model can provide insight how a change to a vertical parameter (e.g., reimbursements from one payer) in conjunction with a change to a horizontal parameter (e.g., readmission rates) can affect financial metrics for an institution as a whole.

While specific user interfaces have been described herein, one of skill in the art will appreciate that the depicted embodiments are provided for the purpose of illustration and should not be construed as limiting the scope of this disclosure. Specifically, one of skill in the art will appreciate that other interfaces, for example, interfaces displaying a different layout, different types of graphs, and/or different graphical input and control elements, may be employed without departing from the scope of this disclosure.

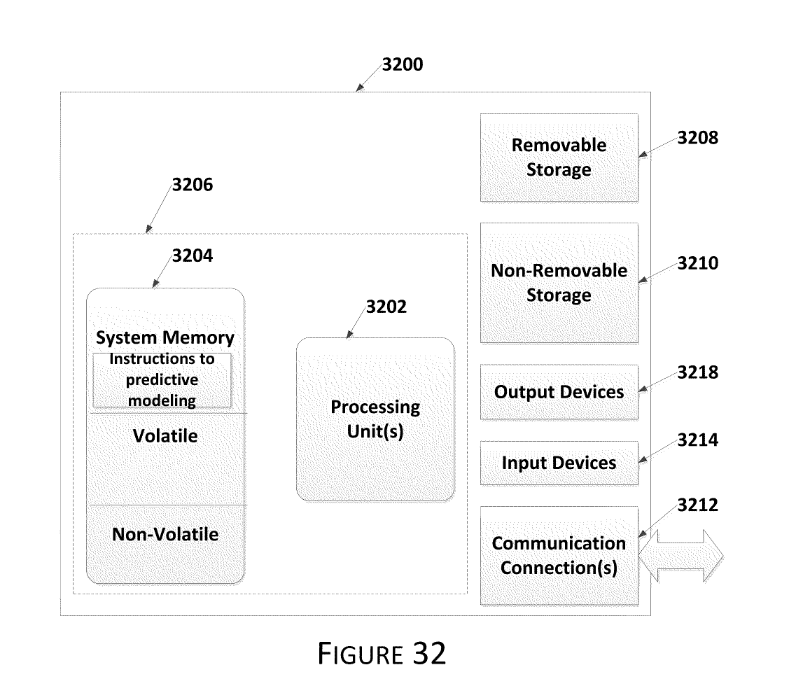

Having described various embodiments of systems, methods, and user interfaces that may be employed to perform predictive modeling analysis for medical facilities, this disclosure will now describe an exemplary operating environment that may be used to perform the systems and methods disclosed herein. FIG. 32 illustrates one example of a suitable operating environment 3200 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 3200 typically includes at least one processing unit 3202 and memory 3204. Depending on the exact configuration and type of computing device, memory 3204 (storing, among other things, reputation information, category information, cached entries, instructions to perform the methods disclosed herein, etc.) may be volatile (such as RAM), non-volatile (such as ROM, flash memory, etc.), or some combination of the two. This most basic configuration is illustrated in FIG. 32 by dashed line 3206. Further, environment 3200 may also include storage devices (removable, 3208, and/or non-removable, 3210) including, but not limited to, magnetic or optical disks or tape. Similarly, environment 3200 may also have input device(s) 3214 such as keyboard, mouse, pen, voice input, etc. and/or output device(s) 3216 such as a display, speakers, printer, etc. Also included in the environment may be one or more communication connections, 3212, such as LAN, WAN, point to point, etc.

Operating environment 3200 typically includes at least some form of computer readable media. Computer readable media can be any available media that can be accessed by processing unit 3202 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 3200 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

This disclosure described some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments were described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A method for performing horizontal analysis of institutional data of a healthcare provider, the method comprising:
receiving an indication of two or more dimensions for a multidimensional query;
performing a multidimensional query of historical data on the two or more dimensions;
generating a set of results based upon the multidimensional query;
determining a baseline model based on the set of results;
receiving an adjustment to a parameter of the baseline model to generate a predictive model; and
simultaneously displaying the adjustment, a first summary financial metric for the baseline model, a second summary financial metric for the predictive model, and at least one difference between the first summary financial metric and the second summary financial metric.

2. The method of claim 1, wherein the multidimensional query is a three dimensional query, and wherein the three dimensions comprise:
patient criteria;
trigger conditions; and
claim criteria.

3. The method of claim 2, further comprising receiving at least a first set of factors for the patient criteria as parameters for the multidimensional query, and wherein the first set of factors include at least one of:
financial data;
payer data;
location;
gender;
age;
diagnosis; and
name.

4. The method of claim 3, further comprising receiving a second set of factors for the trigger conditions as parameters for the multidimensional query, and wherein the second set of factors include at least one of:
a service;
an action; and
a medical event.

5. The method of claim 4, wherein the historical data includes data relating to multiple payers and the parameter is a vertical parameter that affects a first payer of the multiple payers but not a second payer of the multiple payers.

6. The method of claim 4, further comprising receiving a third set of factors for the claim criteria as parameters for the multidimensional query, and wherein the third set of factors include at least one of:
place of service;
code type; and
providers.

7. The method of claim 1, wherein the parameter comprises part of the set of results, and receiving an adjustment to the at least one parameter comprises receiving an adjustment to at least one of:
a reimbursement amount;
a supply cost; and
a number of units.

8. The method of claim 1, wherein the first and second summary financial metrics each comprise at least one of:
total cost;
reimbursement value; and
net revenue.

9. The method of claim 1, wherein the parameter is calculated from the set of results when determining the baseline model.

10. A computer storage medium encoding computer executable instructions that, when executed by at least one processor, perform a method for performing horizontal analysis of institutional data of a healthcare provider, the method comprising:
receiving an indication of two or more dimensions for a multidimensional query;
performing a multidimensional query of historical data on the two or more dimensions;
generating a set of results based upon the multidimensional query;
determining a baseline model based on the set of results;
receiving an adjustment to a parameter of the baseline model to generate a predictive model; and
simultaneously displaying the adjustment, a first summary financial metric for the baseline model, a second summary financial metric for the predictive model, and at least one difference between the first summary financial metric and the second summary financial metric.

11. The computer storage medium of claim 12, wherein the multidimensional query is a three dimensional query, and wherein the three dimensions comprise:
patient criteria;
trigger conditions; and
claim criteria.

12. The computer storage medium of claim 10, wherein the method further comprises receiving at least a first set of factors for the patient criteria as parameters for the multidimensional query, and wherein the first set of factors include at least one of:
financial data;
payer data;
location;
gender;
age;
diagnosis; and
name.

13. The computer storage medium of claim 12, wherein the method further comprises receiving a second set of factors for the trigger conditions as parameters for the multidimensional query, and wherein the second set of factors include at least one of:
a service;
an action; and
a medical event.

14. The computer storage medium of claim 13, wherein the historical data includes data relating to multiple payers and the parameter is a vertical parameter that affects a first payer of the multiple payers but not a second payer of the multiple payers.

15. The computer storage medium of claim 13, wherein the method further comprises receiving a third set of factors for the claim criteria as parameters for the multidimensional query, and wherein the third set of factors include at least one of:
place of service;
code type; and
providers.

16. The computer storage medium of claim 10, wherein the parameter comprises part of the set of results, and receiving an adjustment to the at least one parameter comprises receiving an adjustment to at least one of:
a reimbursement amount;
a supply cost; and
a number of units.

17. The computer storage medium of claim 10, wherein the first and second summary financial metrics each comprise at least one of:
total cost;
reimbursement value; and
net revenue.

18. The computer storage medium of claim 10, wherein the parameter is calculated from the set of results when determining the baseline model.

19. A method for performing vertical analysis of institutional data of healthcare provider, the method comprising:
receiving an indication of two or more dimensions for a multidimensional query;
performing the multidimensional query of historical data on the two or more dimensions, wherein the multidimensional query defines a population, and wherein the population comprises a plurality of payers;
generating a set of results based upon the multidimensional query;
determining a baseline model based on the set of results;
receiving an adjustment to a parameter of the baseline model to generate a predictive model, wherein the parameter is a horizontal parameter that affects multiple payers in the plurality of payers and affects a first payer of the plurality of payers differently from a second payer of the plurality of payers; and
applying the adjustment across the plurality of payers to generate a predictive model.

20. The method of claim 19, further comprising simultaneously displaying the adjustment, a first summary financial metric for the baseline model, and a second summary financial metric for the predictive model.
